(19) United States
(12) Patent Application Publication
(10) Pub. No.: US 2018/0094767 A1
(43) Pub. Date: Apr. 5, 2018

(54) PRECISION AIMING SYSTEMS AND METHODS

(71) Applicant: Charles A. McCoy, II, Bellingham, WA (US)

(72) Inventor: Charles A. McCoy, II, Bellingham, WA (US)

(21) Appl. No.: 15/696,064

(22) Filed: Sep. 5, 2017

Related U.S. Application Data
(60) Provisional application No. 62/383,470, filed on Sep. 4, 2016.

(51) Int. Cl. F16M 11/12; G03B 17/56

(52) U.S. Cl. CPC F16M 11/126; F16M 13/022; G03B 17/561

(57) ABSTRACT

An aiming device comprises a base plate, a top plate, a pivot assembly, a pivot groove, and first and second adjustment systems. The pivot assembly connects the top plate to the base plate for rotation about a first pivot axis. The pivot groove is formed in the top plate to allow deformation of at least a portion of the top plate relative to the base plate about a second pivot axis. The first adjustment system causes relative movement between the top plate and the base plate relative about the first pivot axis. The second adjustment system causes relative movement between at least a portion of the top plate and the bottom plate about the second pivot axis.

### RELATED APPLICATIONS

This application (Attorney's Ref. No. P219273) claims benefit of U.S. Provisional Application Ser. No. 62/383,470 filed Sep. 4, 2016, the contents of which are incorporated herein by reference.

### TECHNICAL FIELD

The present invention relates to aiming systems for allowing precision movement of a pointing device.

### BACKGROUND

A pointing device is a device capable of being aimed at a target. The pointing device thus defines a pointing axis that extends to the operational limits of the pointing device. The present invention is of particular significance when used in conjunction with a spotting scope, and that application of the first example precision aiming devices of the present invention will be described in detail herein. However, the present invention may be used in conjunction with other pointing devices that define such a point axis, such as cameras, telescopes, binoculars, firearms, lasers, and the like, and the scope of the present invention is not limited to a particular type of pointing device.

Pointing devices must be supported such that the pointing axis is aligned with the target. When the target is a significant distance away, minor angular changes to the point axis can result in significant displacement of the pointing axis relative to the target. Aligning the pointing axis with the target can thus be difficult.

The need exists for precision aiming systems and methods that facilitate the alignment of a pointing device with a target.

### SUMMARY

The present invention may be embodied as an aiming device comprising a base plate, a top plate, a pivot assembly, a pivot groove, and first and second adjustment systems. The pivot assembly connects the top plate to the base plate for rotation about a first pivot axis. The pivot groove is formed in the top plate to allow deformation of at least a portion of the top plate relative to the base plate about a second pivot axis. The first adjustment system causes relative movement between the top plate and the base plate relative about the first pivot axis. The second adjustment system causes relative movement between at least a portion of the top plate and the bottom plate about the second pivot axis.

The present invention may also be embodied as a method of aiming a pointing device supported from a support device comprising the following steps. A base plate is secured to the support device. The pointing device is secured to a top plate. A proximal portion of the top plate is pivotably connected to the base plate for rotation about a first pivot axis. A pivot groove is formed in the top plate for allowing deformation of a distal portion of the top plate relative to the proximal portion of the top plate about a second pivot axis. The top plate is displaced relative to the base plate about the first pivot axis. The distal portion of the top plate is displaced relative to the proximal portion of the top plate about the second pivot axis.

The present invention may also be embodied as an aiming device for use with a pointing device and a support device. In this context, the aiming device of the present invention comprises a base plate, a top plate, a pivot assembly, a pivot groove, and first and second adjustment systems. The base plate is adapted to be detachably attached to the support device. The top plate is adapted to be detachably attached to the pointing device. The pivot assembly connects a proximal portion of the top plate to the base plate for rotation about a first pivot axis. A pivot groove is formed in the top plate to allow deformation of a distal portion of the top plate relative to the proximal portion of the top plate about a second pivot axis. The first adjustment system, which causes relative movement between the top plate and the base plate relative about the first pivot axis, comprises an intermediate member and an adjustment rod. The intermediate member is supported by the top plate for movement along a first adjustment axis. The adjustment rod is supported by the top plate for axial rotation relative to the first adjustment axis. The first adjustment system acts on the intermediate member to cause relative movement between the top plate and the base plate. The second adjustment system comprises an adjustment wheel and causes relative movement between the distal portion of the top plate and the proximal portion of the top plate about the second pivot axis. The adjustment wheel is supported relative to the base plate and such that axial rotation of the adjustment wheel about the second adjustment axis causes displacement of distal portion of the top plate relative to the proximal portion of the top plate and thus to the base plate.

### BRIEF DESCRIPTION OF THE DRAWINGS

FIG. 1 is a side elevation view of a first example precision aiming system of the present invention shown in use with an example pointing device and an example support device;

FIGS. 2A, 2B, and 2C are views through the example pointing device illustrating precision adjustment of the pointing device using the first example precision aiming system;

FIG. 3 is a bottom plan view of the first example precision aiming system;

FIG. 4 is a first side view of the first example precision aiming device with an example second adjustment system thereof in a first end position;

FIG. 5 is a second side view of the first example precision aiming device with the example second adjustment system thereof in the first end position;

FIG. 6 is a top plan view of the first example precision aiming device;

FIG. 7 is a section, partially exploded view taken along lines 7-7 in FIG. 3 illustrating the example second adjustment system in the first end position and also the connection of the first example precision aiming device to the example pointing device and the example support device;

FIG. 7A is an enlarged portion of FIG. 7;

FIG. 8 is a partial section view taken along lines 8-8 in FIG. 3 illustrating an adjustment portion of an example first adjustment system of the first example precision aiming device;

FIG. 9 is a partial section view taken along lines 9-9 in FIG. 3 illustrating a limit portion of the example first adjustment system of the first example precision aiming device;

FIG. 10 is a side elevation, exploded, partial section view taken along lines 7-7 in FIG. 3;

FIG. 11 is a side elevation view, exploded, partial section view taken along lines 8-8 in FIG. 3;

FIG. 12 is a bottom plan view of a base plate of the first example precision aiming device;

FIG. 13 is a bottom plan view of an intermediate plate or member of the first example precision aiming device;

FIG. 14 is a bottom plan view of a top plate of the first example precision aiming device;

FIG. 15 is the first side view of the second example precision aiming device with the first adjustment system thereof in a second end position;

FIG. 16 is a section, partially exploded view taken along lines 7-7 in FIG. 3 illustrating the second adjustment system in the second end position;

FIG. 17 is a bottom plan view of the first example precision aiming system illustrating the second adjustment system in a first end position;

FIG. 18 is a section view taken along lines 18-18 in FIG. 17;

FIG. 19 is a section view taken along lines 19-19 in FIG. 17;

FIG. 20 is a bottom plan view of the first example precision aiming system illustrating the second adjustment system in a second end position;

FIG. 21 is a section view taken along lines 21-21 in FIG. 20 illustrating;

FIG. 22 is a section view taken along lines 22-22 in FIG. 20;

FIG. 23 is a bottom plan view of a second example precision aiming system of the present invention;

FIG. 24 is a side elevation view of the second example precision aiming system in a centered vertical adjustment configuration;

FIG. 25 is a top plan view of the second example precision aiming system in a centered lateral adjustment configuration;

FIG. 26 is a section view of the second example precision aiming system taken along lines 26-26 in FIG. 23;

FIG. 27 is a detail view of a portion of FIG. 26;

FIG. 28 is a detail view of a portion of FIG. 26 illustrating a second (vertical) adjustment system of the second example precision aiming system in the centered vertical adjustment configuration;

FIG. 29 is a section view of the second example precision aiming system taken along lines 29-29 in FIG. 23 illustrating a first (lateral) adjustment system of the second example precision aiming system in the centered lateral adjustment configuration;

FIG. 30 is an exploded view of a pivot assembly of the second example precision aiming system;

FIG. 31 is an exploded view of an intermediate connecting assembly of the second example precision aiming system;

FIG. 32 is an exploded, partial section view of the second adjustment assembly of the second example precision aiming system;

FIG. 33 is an exploded, partial section view of the first adjustment assembly of the second example precision aiming system;

FIG. 34A is a section view of an intermediate block or member of the example first adjustment assembly;

FIG. 34B is a top plan view of the intermediate block;

FIG. 34C is an end elevation view of the intermediate block;

FIG. 34D is a bottom plan view of the intermediate block;

FIG. 34E is a side elevation view of the intermediate block;

FIG. 35 is a top plan view of a base plate of the second example precision aiming system;

FIG. 36 is a bottom plan view of a top plate of the second example precision aiming system;

FIG. 37 is a bottom view of a top plate assembly of the second example precision aiming system;

FIG. 38 is a side elevation view similar to FIG. 24 illustrating the second example precision aiming system in an offset vertical adjustment configuration;

FIG. 39 is a detail view similar to FIG. 28 illustrating the second adjustment system in the offset vertical adjustment configuration;

FIG. 40 is a top plan view of the second example precision aiming system in an offset lateral adjustment configuration; and

FIG. 41 is a section view similar to FIG. 29 illustrating the first adjustment system of the second example precision aiming system in the offset lateral adjustment configuration.

### DETAILED DESCRIPTION

The present invention may be embodied in different forms, and two example precision aiming systems of the present invention will be described separately herein.

In the context of the two embodiments of the present invention, the term “pointing device” refers to any device capable of being aimed at a target. The pointing device thus defines a pointing axis that extends to the operational limits of the pointing device. The present invention is of particular significance when used in conjunction with a spotting scope, and that application of the first example precision aiming devices of the present invention will be described in detail herein. However, the present invention may be used in conjunction with other pointing devices that define such a point axis, such as cameras, telescopes, binoculars, firearms, lasers, and the like, and the scope of the present invention is not limited to a particular type of pointing device.

In the following discussion, the terms “horizontal” and “vertical” refer to true horizontal and vertical. The terms “upper”, “lower”, “top”, and “bottom” refer to positions or directions relative to vertical. The terms “left”, “right”, and “lateral” refer to horizontal positions or directions. The example precision aiming systems described herein are typically used in a predetermined orientation relative to horizontal and vertical, and, for purposes of clarity, the following discussion assumes that the example precision aiming systems are in that predetermined orientation. When the example precision aiming systems described herein are arranged in orientations other than the predetermined orientation, the terms “upper”, “lower”, “top”, “bottom”, “left”, “right”, and “lateral” as used herein may no longer refer to true horizontal and true vertical.

Further, the two example embodiments described below may be used in the same general manner.

### I. First Example Precision Aiming System

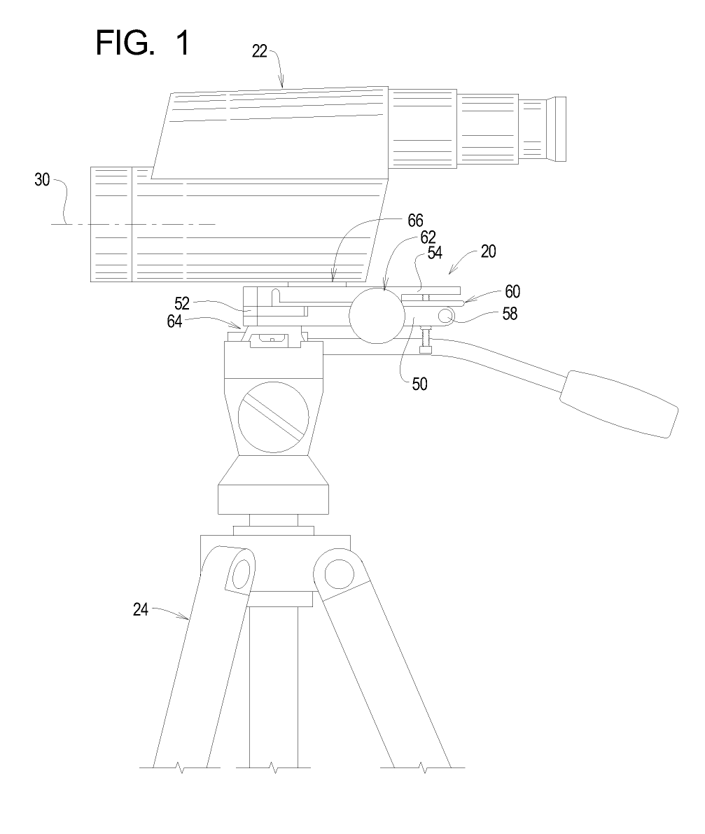

Referring initially to FIG. 1, depicted therein is a first example precision aiming system 20, constructed in accordance with, and embodying, the principles of the present invention. As shown in FIG. 1, the first example precision aiming device 20 is operatively connected between an example pointing device 22 and an example support device 24. The example pointing device 22 depicted in FIG. 1 is a spotting scope.

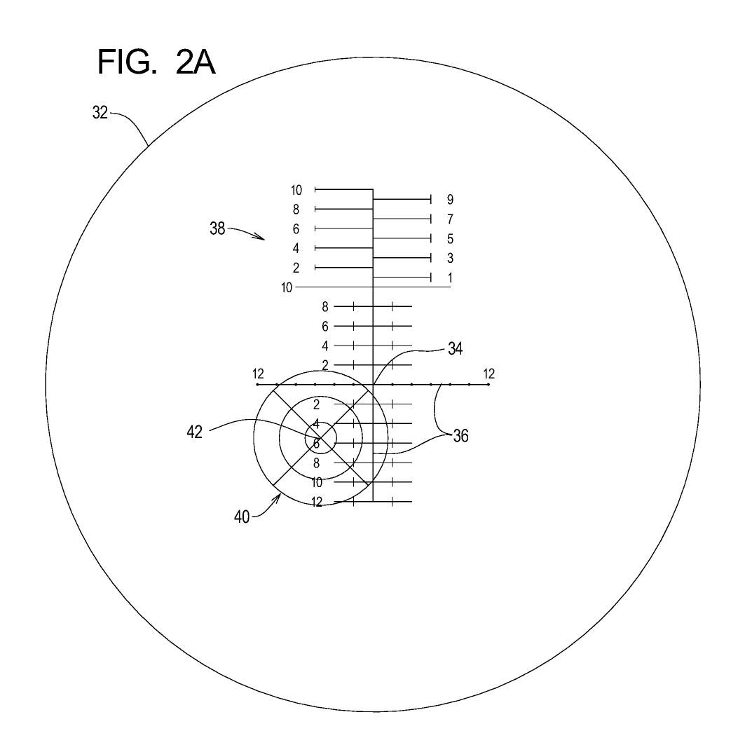

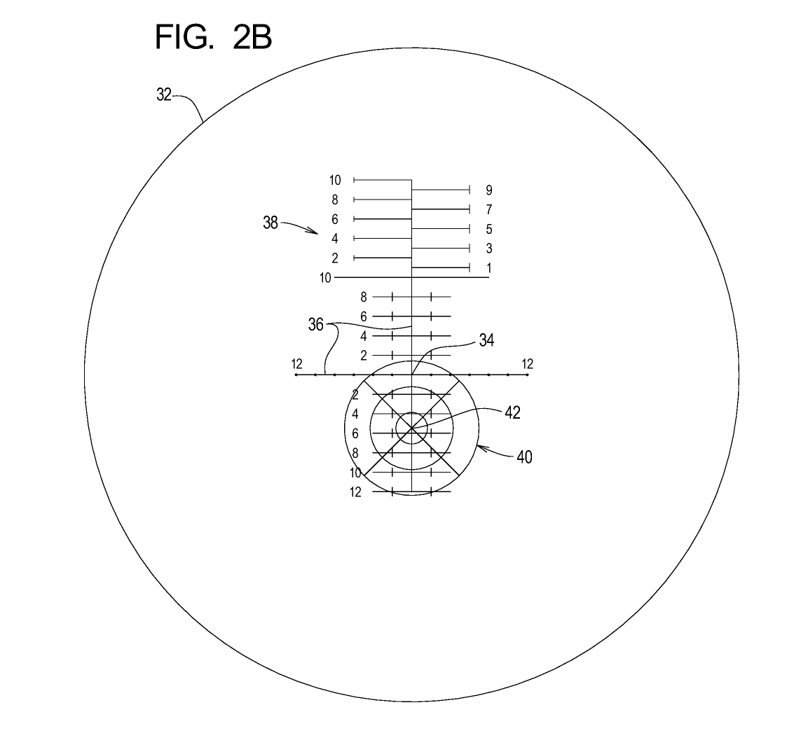

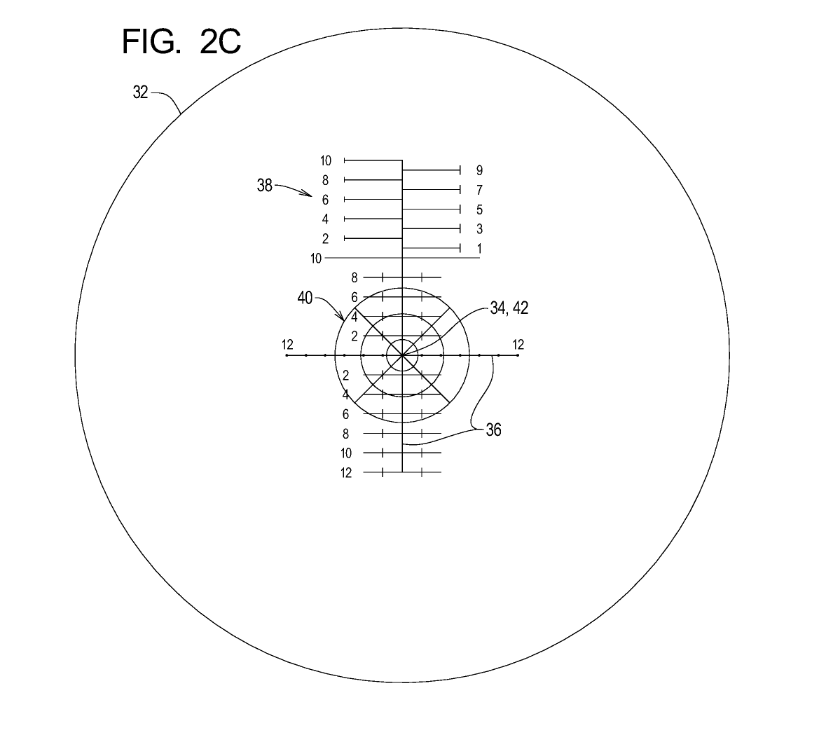

Referring now to FIGS. 2A, 2B, and 2C, depicted therein is a view through the spotting scope forming the example pointing device 22. The optics of the example spotting scope define a pointing field of view 32 having a field of view center point 34. The field of view center point 34 lies on a pointing axis 30 and is marked by cross hairs 36 viewable through the spotting scope optics. The cross hairs 36 may be supplemented by additional information 38 as illustrated in FIGS. 2A, 2B, and 2C. FIGS. 2A, 2B, and 2C further illustrate a target 40 visible through the spotting scope forming the example pointing device 22. The target 40 defines a target center 42.

The example support device 24 is a conventional tripod assembly capable of supporting the example pointing device 22 directly such that the pointing device may be pivoted about first and second horizontal support axes and a rotated about a vertical support axis. With the example pointing device 22 supported directly on the support device 24, the user may level the pointing device 22 by pivoting the pointing device 22 about the first horizontal support axis. The user may further move the pointing axis 30 laterally left and right by rotating the pointing device 22 about the vertical support axis and move the pointing axis up and down by pivoting the pointing device 22 about the second horizontal support axis.

A tripod type support device 24 with three axes of adjustment is conventional and allows gross adjustment of the direction of the pointing axis 30 of the example pointing device 22. However, the operating range of many pointing devices, such as the spotting scope used as the example pointing device 22, is so great that only a minor angular change about the second horizontal support axis or about the vertical support axis results in significant movement of the pointing axis relative to the target 40 and to the target center 42 in particular. Using a conventional tripod type support device as the support device 24, it is very easy to overcorrect when using the support device 24 to align the pointing axis 30 with the target center 42.

The purpose of the first example precision aiming system 20 is to facilitate fine adjustment of the pointing device 22 such that the pointing axis 30 may easily and precisely be arranged to extend through the target center 42. More specifically, once the target 40 is arranged somewhere within the field of view 32 as shown in FIG. 2A using the support device 24, the first example precision aiming system 20 may be used to move the pointing axis 30 such that the field of view center point 34 overlies the target center 42, indicating that the pointing axis 30 extends through the target center 42.

FIG. 2A thus illustrates a starting position of the example pointing device 22 relative to the target 40 prior to using the first example aiming system 20. In FIG. 2A, the field of view center 34 is high and to the right of the target center 42, indicating that the pointing axis 30 does not extend through the target center 42. The precision aiming system 20 is operated to move the pointing axis 30 laterally to the left such that the field of view center 34 is directly above the target center 42 as shown in FIG. 2B. The precision aiming system 20 is next operated to move the pointing axis 30 vertically downward such that the field of view center 34 directly overlies the target center 42 as shown in FIG. 2C. At this point, the pointing axis 30 extends through the target center 42. The precision aiming system 20 may thus be used to yield fine adjustment of the direction at which the pointing axis 30 extends.

With the foregoing general understanding of the operation of the first example precision aiming system 20 in mind, the details of the construction and operation of the first example precision aiming system 20, and the connection of the first example aiming system 20 to the pointing device 22 and support device 24, will now be described in detail.

FIG. 1 illustrates that the first example aiming system 20 comprises a base plate 50, an intermediate plate or member 52, a top plate 54, a main screw assembly 54, a level indicator 58, a first (lateral) adjustment system 60, a second (vertical) adjustment system 62, a support mounting system 64, and a device mounting system 66. The main screw assembly 56 joins the base plate 50, intermediate plate 52, and top plate 54 together such that the intermediate plate 52 and top plate 54 may rotate about a screw axis SA defined by the main screw assembly 54 relative to the bottom plate 50. The example top plate 54 is configured such that at least a portion of the top plate 54 may be flexed about a flex axis A2 relative to the intermediate plate 52.

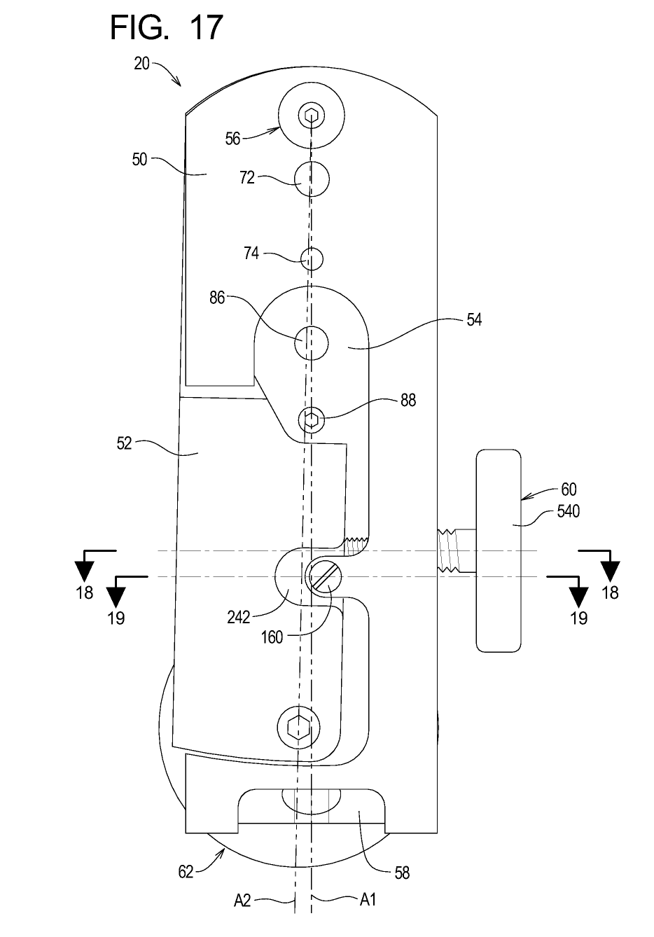

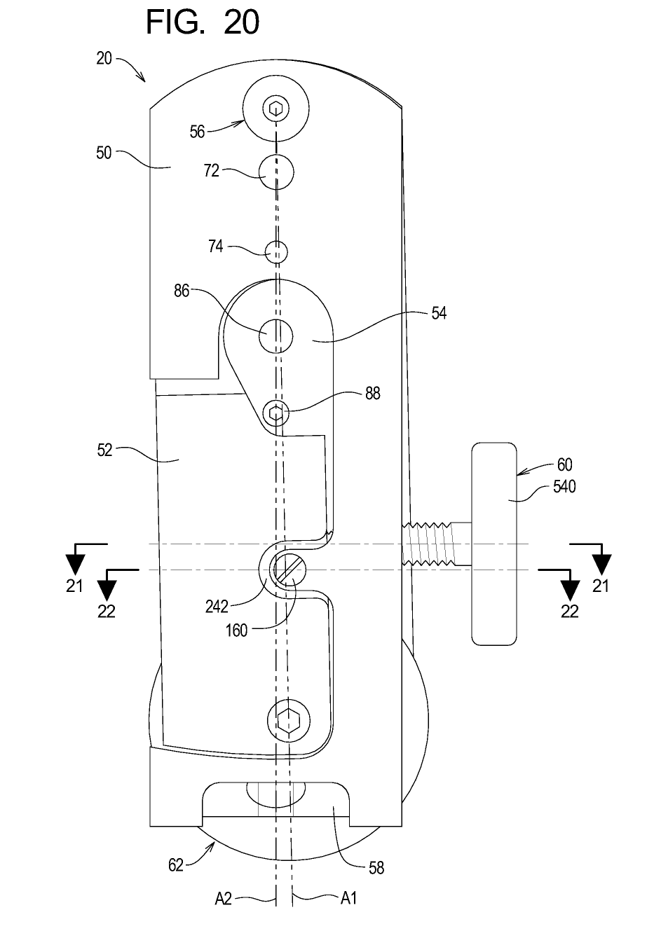

The first adjustment system 60 is configured to cause the intermediate plate 52 and top plate 54 to rotate about the screw axis SA. As perhaps best shown in FIGS. 17 and 20, the base plate 50 defines a base plate axis A1, while the intermediate plate 52 defines an intermediate plate axis A2. Operation of the first adjustment system 60 allows an angle between the base plate axis Al and the intermediate plate axis A2 to be changed as shown by a comparison of FIGS. 17 and 20. During normal use of the first example precision aiming system 20, operation of the first adjustment system 60 results in lateral adjustment of the pointing axis 30.

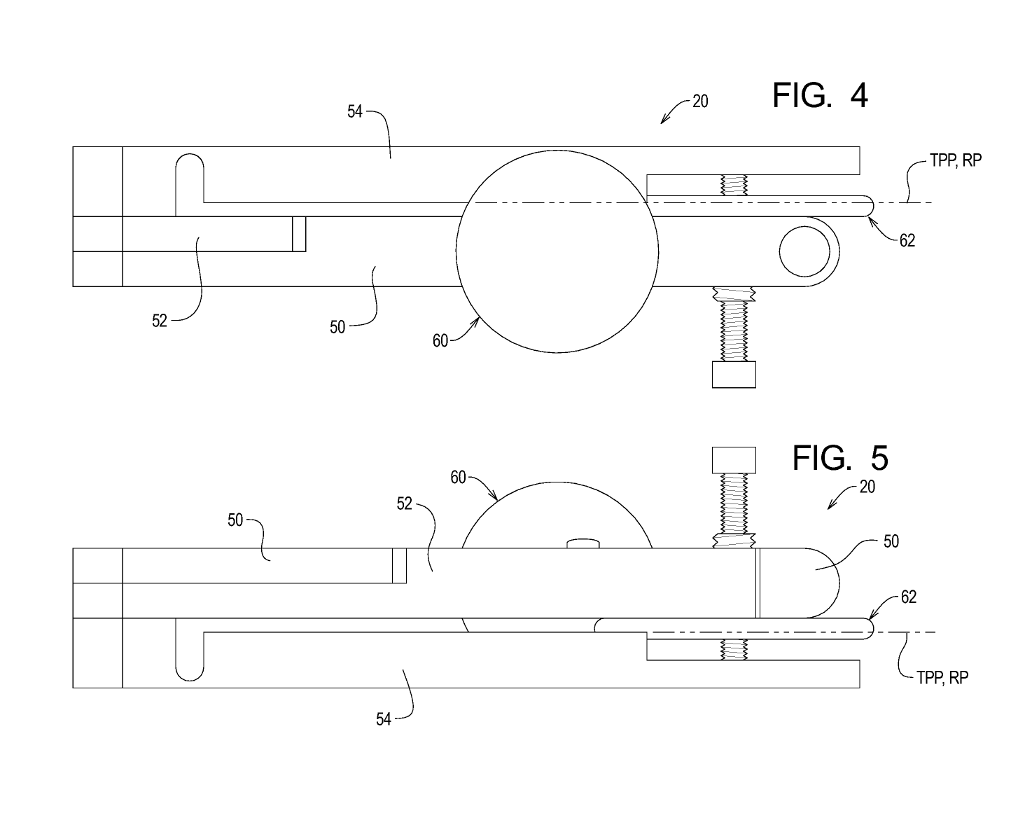

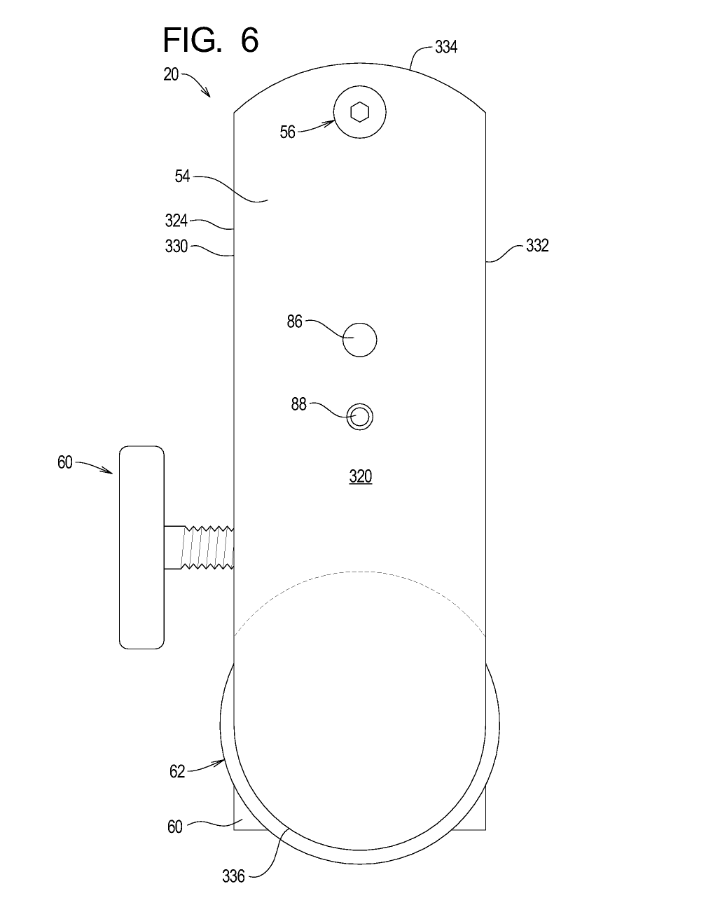

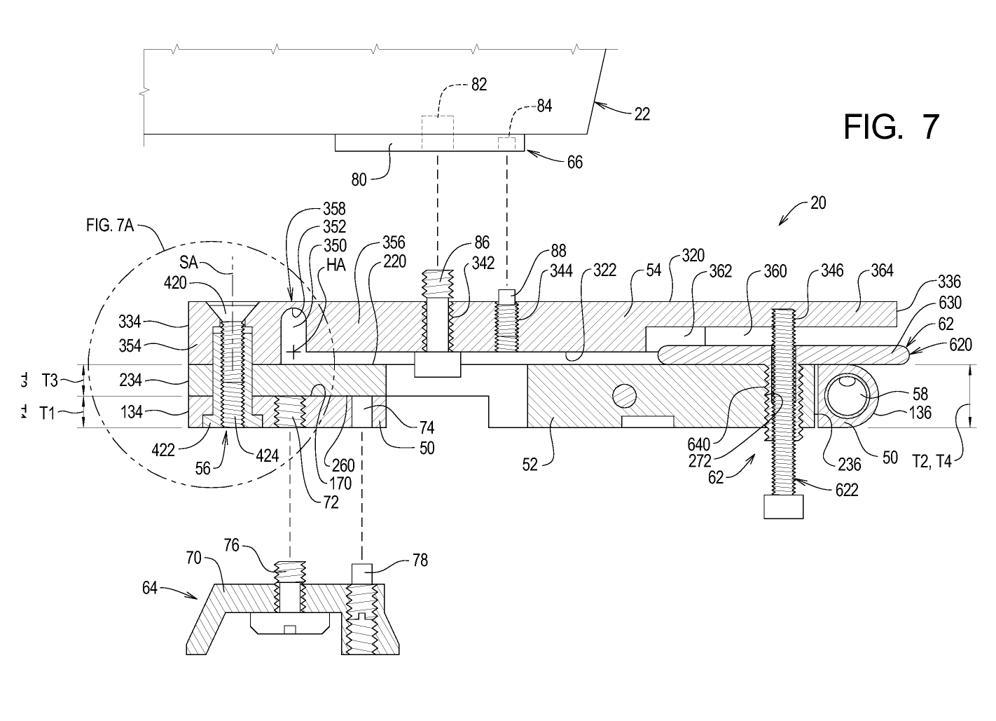

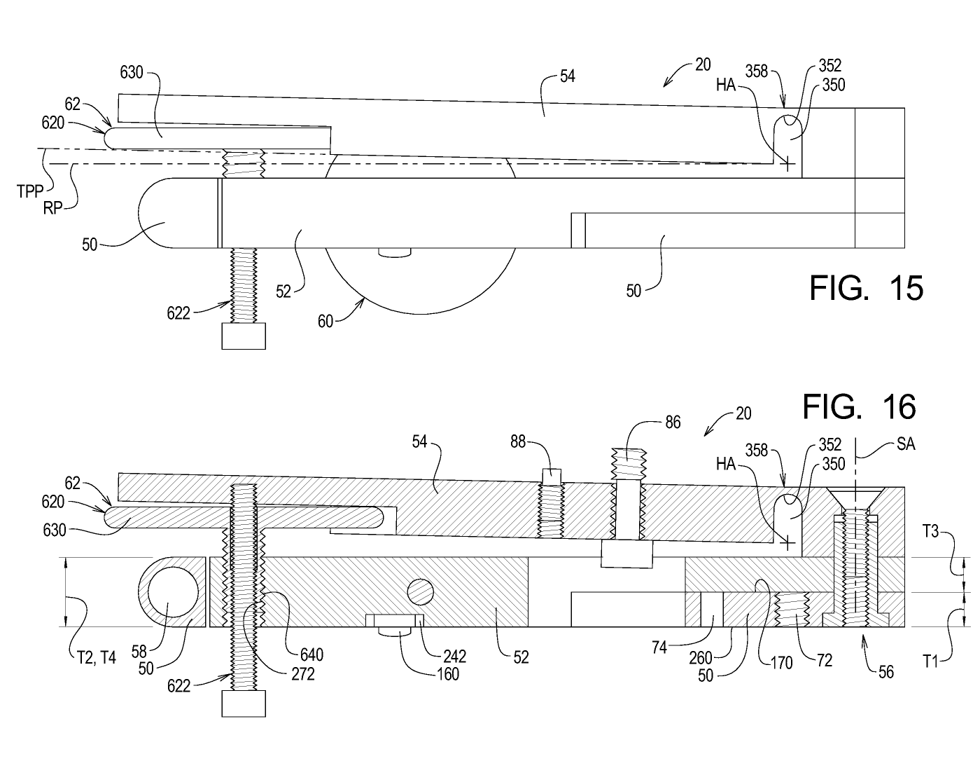

The second adjustment system 62 is configured to cause the top plate 54 to flex, as shown in FIGS. 7 and 16, about a hinge axis HA relative to the intermediate plate 52. In particular, at least a portion of the top plate 52 defines a top plate plane TPP as shown in FIGS. 4, 5, and 15. The top plate plane TPP is coplanar with a reference plane RP with the top plate 52 in a first configuration as shown in FIGS. 4 and 5. The top plate plane TPP is spaced from the reference plane RP when the top plate is in a second configuration as shown in FIG. 15. During normal use of the first example precision aiming system 20, operation of the second adjustment system 62 results in vertical adjustment of the pointing axis 30.

Referring now for a moment to FIG. 7, the example support mounting system 64 will be described in further detail. FIG. 7 shows that the example support device 24 defines a support mounting plate 70 and that the example base plate 50 defines a support mounting cavity 72 and a support alignment cavity 74. A support mounting screw 76 and a support alignment peg 78 extend from the support mounting plate 70 and are received within the support mounting cavity 72 and the support alignment cavity 74, respectively, to mount the precision aiming system 20 to the support device 24. The support mounting cavity 72, support alignment cavity 74, support mounting screw 76, and support alignment peg 78 all are or may be conventional and will not be described herein in further detail.

FIG. 7 also shows the example device mounting system 66. The example pointing device 22 defines a device mounting plate 80 defining a device mounting cavity 82 and a device alignment cavity 84. A device mounting screw 86 and a device alignment peg 88 extend from the top plate 54 and are received within the device mounting cavity 82 and the device alignment cavity 84, respectively, to mount the pointing device 22 to the precision aiming system 20. The device mounting cavity 82, device alignment cavity 84, device mounting screw 86, and device alignment peg 88 all are or may be conventional and will not be described herein in further detail.

With the base plate 50 of the precision aiming system 20 secured to the support device 24 by the support mounting system 64 and the pointing device 22 secured to the top plate 54 of the precision aiming system 20, movement of the top plate 54 relative to the base plate 50 results in movement of the aiming device 22 relative to the support device 24 and thus movement of the pointing axis 30.

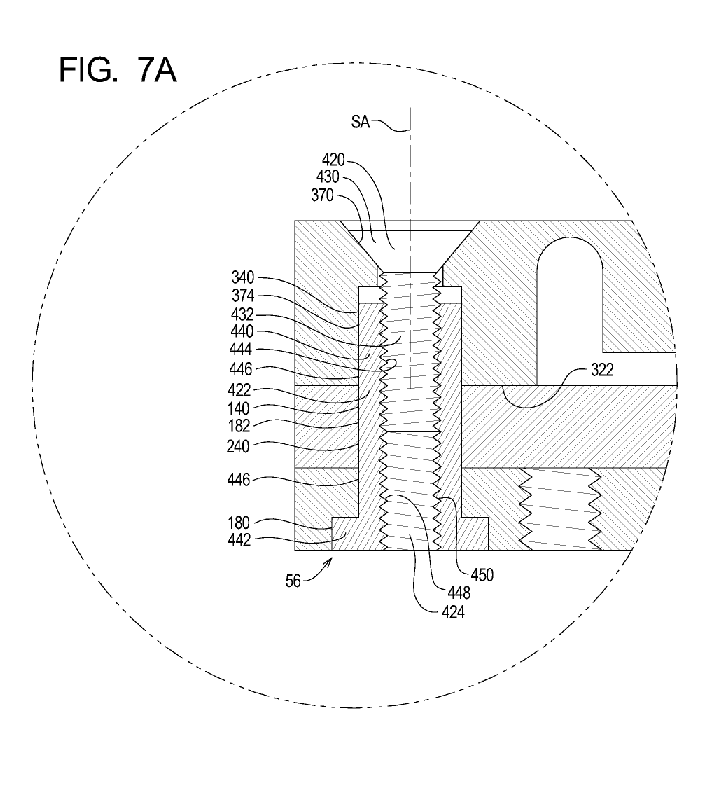

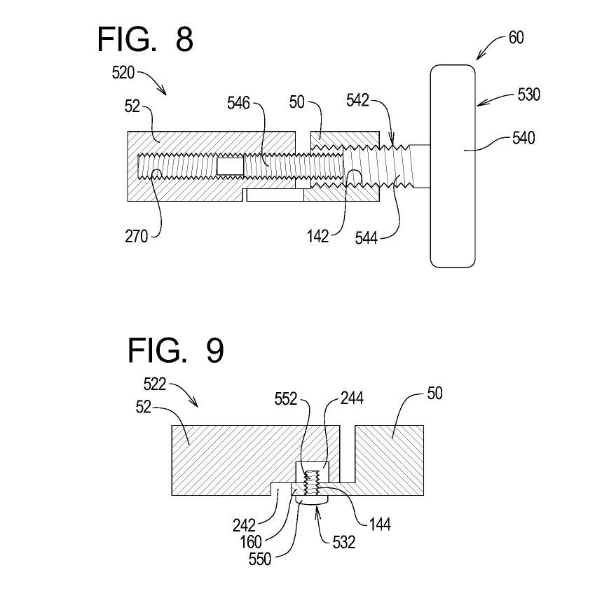

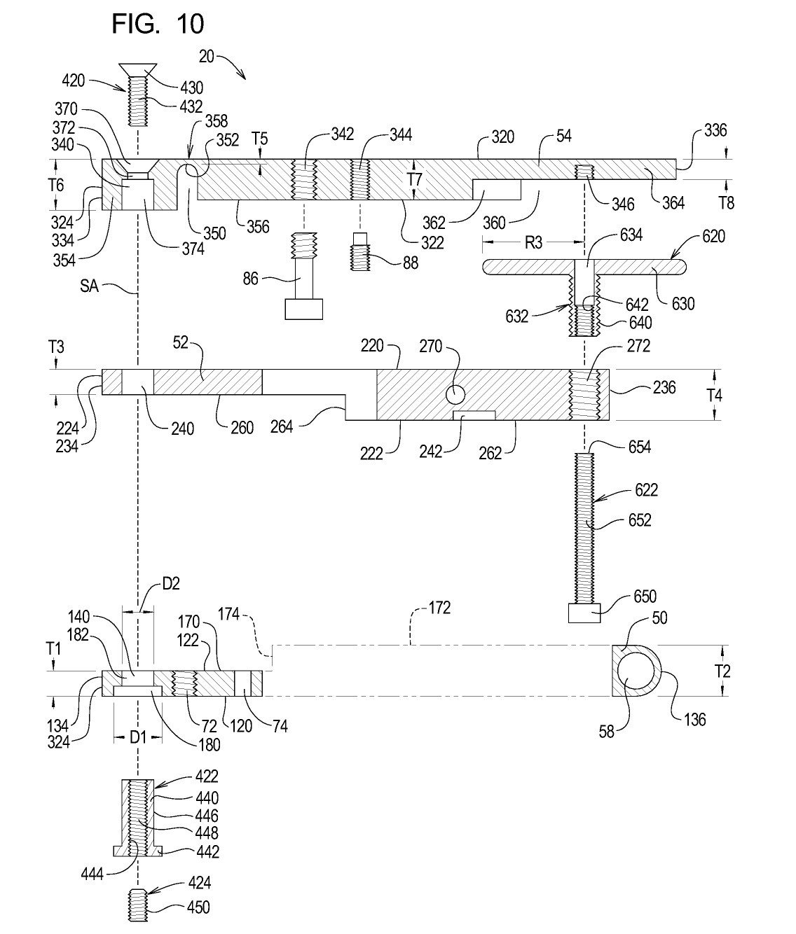

FIGS. 10 and 12 illustrate that the example base plate 50 defines a base plate lower surface 120, a base plate upper surface 122, and a base plate edge surface 124. The base plate edge surface 124 defines a first side portion 130, a second side portion 132, a proximal end portion 134, and a distal end portion 136. The terms “proximal” and “distal” are used herein with reference to the screw axis SA. The example base plate 50 further defines a base plate main hole 140, a base plate adjustment opening 142 (FIG. 8), a base plate stop hole 144, a pair of level mounting holes 146, and a level viewing notch 148. While the base plate first side portion 130 is or may be linear, the base plate second side portion 132 is non-linear such that an edge notch 150 is formed in the example base plate 50. The example base plate edge notch 150 defines a base notch receiving portion 152 and a base notch access portion 154. The base plate stop hole 144 is formed in a stop projection 160 that extends over a portion of the base notch receiving portion 152 for reasons that will become apparent from the following discussion of the example first adjustment system 60.

The example base plate upper surface 122 defines a proximal surface portion 170 and a distal surface portion 172. A thickness T1 of the proximal surface portion 170 is thinner than a thickness T2 of the distal surface portion 172 such that a portion of the base plate upper surface 122 defines a base plate step wall 174. The base plate main hole 140 defines a lower portion 180 and an upper portion 182. The example base plate main hole lower and upper portions 180 and 182 are cylindrical, with a diameter D1 of the lower portion 180 greater than a diameter D2 of the upper portion 182.

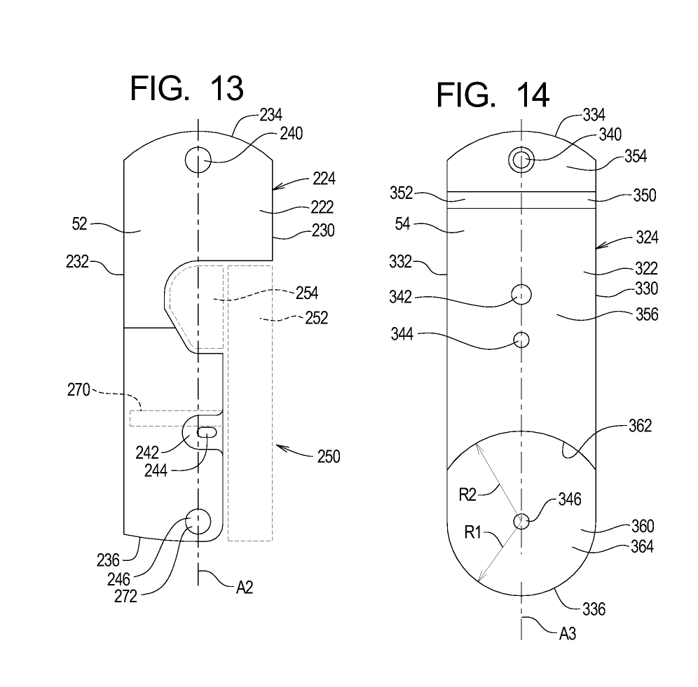

As shown in FIGS. 10 and 13, the example intermediate plate 52 defines an intermediate plate upper surface 220, an intermediate plate lower surface 222, and an intermediate plate edge surface 224. The edge surface 224 defines a first side portion 230, a second side portion 232, a proximal end portion 234, and a distal end portion 236. The example intermediate plate 52 further defines an intermediate plate main hole 240, a stop projection recess 242, a stop slot 244, and an intermediate plate anchor opening 246. The intermediate plate first side edge portion 230 is straight, while the intermediate plate second side edge portion 232 defines an intermediate plate edge notch 250. The intermediate plate edge notch 250 defines an intermediate plate receiving portion 252 and an intermediate plate access portion 254. The example intermediate plate main hole 240 is cylindrical.

The intermediate plate lower surface 222 defines a proximal lower surface portion 260 and a distal lower surface portion 262. A thickness T3 of the intermediate plate 52 within the proximal lower portion 260 is smaller than a thickness T4 of the intermediate plate 52 within the distal lower portion 262. Accordingly, a portion of the intermediate plate lower surface 222 between the portions 260 and 262 defines intermediate plate a step wall 264. First and second adjustment openings 270 and 272 are formed in the example intermediate plate 52 as will be described in further detail below.

FIGS. 10 and 14 illustrate that the example top plate 54 defines a top plate upper surface 320, a top plate lower surface 322, and a top plate edge surface 324. The top plate edge surface 324 defines a first side edge portion 330, a second side edge portion 332, a proximal end portion 334, and a distal end portion 336. The example top plate 54 further defines a top plate main hole 340, a top plate mounting opening 342, a top plate alignment opening 344, and a top plate anchor opening 346. The device mounting screw 86 extends through the top plate mounting opening 342, and the device alignment peg 88 is at least partly supported within the top plate alignment opening 344.

The example top plate inner surface 322 is substantially planar except where a hinge notch 350 is formed. The hinge notch 350 is defined by an elongate, U-shaped hinge portion 352 of the inner surface 320. The hinge notch 350 divides the top plate lower surface 322 into a proximal portion 354 and an intermediate portion 356. The hinge notch 350 defines a deformable portion 358 having a thickness T5. The proximal and intermediate portions 354 and 356 define thicknesses T6 and T7 of the top plate 54, respectively. The example top plate 54 further defines a wheel notch 360 that defines a curved portion 362 and a distal portion 364 of the top plate lower surface 322. The distal portion 364 defines a thickness T8 of the top plate 54. The thickness T8 is less than the thickness T7 of the intermediate portion 356, and the curved surface portion 362 forms a transition between the intermediate surface portion 356 and the distal surface portion 364.

FIG. 14 further shows that the distal end edge portion 336 defines a radius R1 and that the curved surface portion 362 defines a radius R2, where radii R1 and R2 extend from the top plate anchor opening 346.

The example top plate main hole 340 defines an upper portion 370, a neck portion 372, and a lower portion 374. The example upper portion 370 is conical, and the example neck portion 372 and lower portion 372 are cylindrical, with the diameter of the neck portion 372 reduced in comparison to the diameter of the lower portion 374.

The example deformable portion 358 of the top plate 54 is sized and dimensioned to allow flex of the top plate 54, thereby allowing the distal end portion 336 to be displaced relative to the proximal end portion 334 with deliberate application of mechanical force but not with the deliberate application of unaided manual force under most circumstances.

In particular, the example base plate 50, example intermediate plate 52, and example top plate 54 are made of a relatively rigid material capable of deforming under certain circumstances. Examples of materials that may be used to form the example plates 50, 52, and 54 are plastic, reinforced plastic, composite materials, and metals such as steel, titanium, and aluminum. The example base plate 50, intermediate plate 52, and top plate 54 are made of machined aluminum. Aluminum is light weight and relatively rigid under most conditions but is capable of bending at the deformable portion 358 defined by the hinge notch 350 as will be described in further detail below. While the example plates 50, 52, and 54 are depicted as solid in the drawing for purposes of clarity, voids (not shown) may be strategically formed in one or more of these plates 50, 52, and 54 to reduce weight where solid structure is not required. The example plates 50, 52, and 54 all include at least one surface void to reduce weight without compromising structural integrity of the plates 50, 52, and 54 when used as described below.

Referring now for a moment to FIG. 10, it can be seen that the thicknesses T2 and T4 are approximately equal and that the thicknesses T1 and T3, when added together, are approximately equal to either T2 or T4. FIGS. 7 and 16 illustrate that this arrangement of thicknesses T1, T2, T3, and T4 allows the base plate proximal surface portion 170 to engage the intermediate plate proximal surface portion 260 within the same approximate thickness as defined by thickness T2 and T4. The structure of the base plate 50 and the intermediate plate 52 thus nests in a vertical dimension to reduce an overall thickness of the first example precision aiming system 20.

FIGS. 10, 12, and 13 illustrate that the receiving portion 152 defined by the base plate 50 and the receiving portion 252 defined by the intermediate plate 52 are sized and dimensioned such that the base plate 50 and intermediate plate 52 can be nested together to minimize a form factor of the first example precision aiming system 20 in the horizontal dimensions. This configuration also allows the combined form factor of the base plate 50 and the intermediate plate 52 in a horizontal dimension to stay within a form factor as substantially defined by the top plate 54 as shown in FIG. 14.

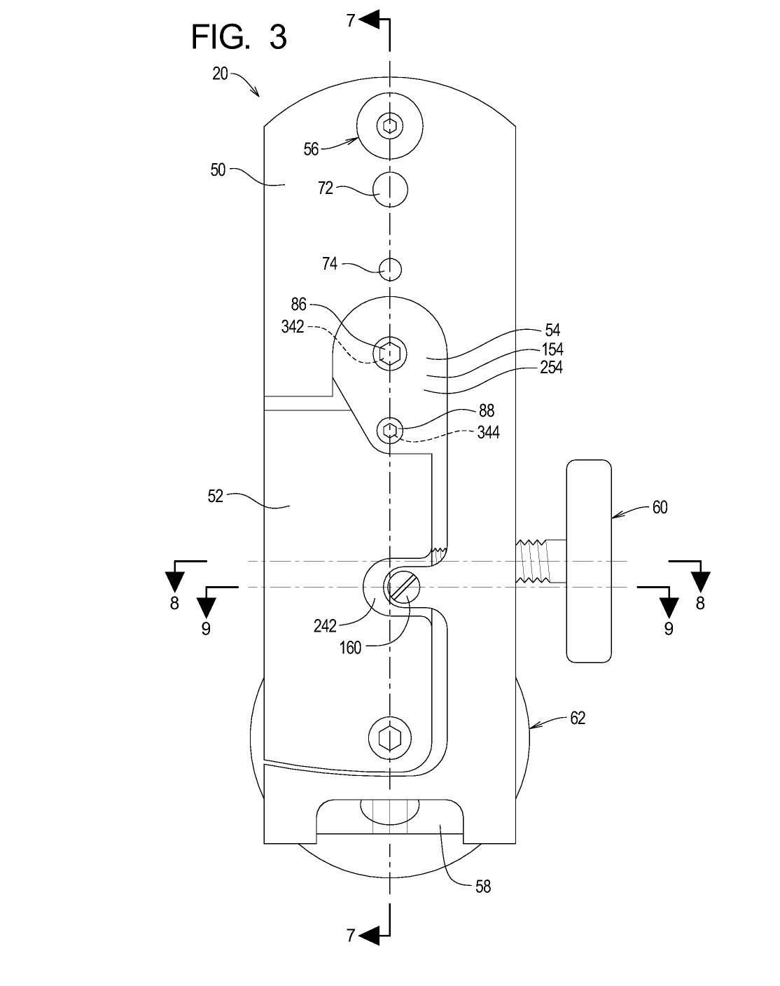

FIG. 3 further illustrates that the arrangement of the access portion 154 defined by the base plate 50 and the access portion 254 defined by the intermediate plate 52 to line up such that access to the top plate mounting opening 342 and alignment opening 344 and thus the device mounting screw 86 and device alignment peg 88 supported within, respectively.

Turning now to FIGS. 7 and 10, the example main screw assembly 56 will now be described in further detail. As shown in FIG. 10, the example main screw assembly 56 comprises a main screw 420, a main sleeve 422, and a lock screw 424. The main screw 420 defines a main screw head 430 and a threaded main screw shaft 432. The main sleeve 422 defines a sleeve shaft 440 and a sleeve head 442. The main sleeve 422 further defines a threaded sleeve inner surface 444 and a sleeve shaft outer surface 446. The sleeve inner surface 444 defines a sleeve bore 448. The example sleeve head 442 and the example sleeve shaft 444 are both cylindrical, and a diameter of the sleeve head 442 is greater than a diameter of the sleeve shaft 444. An outer surface 450 of the lock screw 424 is threaded.

As shown in FIGS. 7 and 7A, the main screw 420 is inserted through the top plate main hole 340 such that the main screw head 430 is within the upper portion 370 of the top plate main hole 340. The main sleeve 422 is inserted through the base plate main hole 140 until the sleeve head 442 is within the base plate main hole lower portion 180. The diameter of the sleeve shaft outer surface 446 is substantially the same as that of the base plate main hole upper portion 182.

The intermediate plate 52 is then arranged such that the base plate proximal inner surface portion 170 engages the intermediate plate proximal lower surface portion 260 and the intermediate plate main hole 240 receives the sleeve shaft 440. The diameter of the sleeve shaft outer surface 446 is substantially the same as that of the intermediate plate main hole 240.

The top plate 54 and main screw 420 are then displaced until the intermediate plate upper surface 220 engages the top plate lower surface 322 and the top plate main hole sleeve portion 374 receives the sleeve shaft 440. The diameter of the sleeve shaft outer surface 446 is substantially the same as that of the top plate main hole sleeve portion 374. The main screw 420 is then axially rotated such that the screw shaft 432 thereof engages the sleeve inner surface 444 and threads into sleeve bore 448. The threaded outer surface 450 of the lock screw 424 is engaged with the sleeve inner surface 444 and axially rotated such that the lock screw threads into the sleeve bore and engages the main screw 420 to inhibit inadvertent removal of the main screw 420.

With the main screw assembly 56 formed as shown in FIG. 7, the main screw head 430 and sleeve head 442 effectively clamp the proximal ends 134, 234, and 334 of the plates 50, 52, and 54 together. At this point, the stop projection 160 extending from the base plate 50 is arranged within the stop projection recess 242 in the intermediate plate 52 with the stop hole 144 adjacent to the stop slot 244. Again, arranging the stop projection 160 within the stop recess 242 minimizes a total thickness of the base plate 50 and the intermediate plate 52 in the vertical dimension.

The sleeve outer surface 446 allows rotation of the plates 50, 52, and 54 relative to each other about the screw axis SA. However, after the example second adjustment system 62 is formed, axial rotation, or any movement, of the intermediate plate 52 relative to the top plate 54 is substantially prevented.

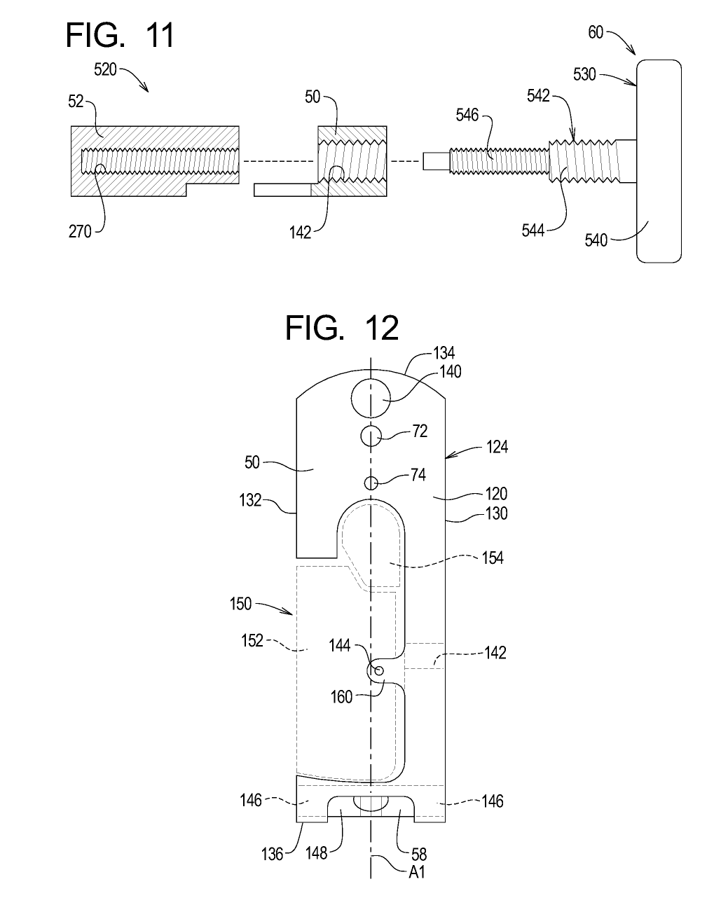

Turning now to FIGS. 8, 9, and 11, the first example adjustment system 20 will now be described. FIG. 8 illustrates a displacement portion 520 of the first example adjustment system 20, while FIG. 9 illustrates a limit portion of the first example adjustment system 20.

FIGS. 8 and 9 illustrate that the example displacement portion 520 comprises a first adjustment member 530 and a stop screw 532. The example first adjustment member 530 defines a knob portion 540 and a shaft portion 542. The shaft portion 542 defines a first shaft portion 544 and a second shaft portion 546. The first and second shaft portions 544 and 546 are both threaded, a diameter of the first shaft portion 544 is greater than a diameter of the second shaft portion 546, and the first shaft portion 544 is arranged between the knob portion 540 and the second shaft portion 546. The displacement portion 520 is formed by threading the first shaft portion 544 into the adjustment opening 142 in the base plate 50 while simultaneously threading the second shaft 546 into the first adjustment opening 270 in the intermediate plate 52. When the displacement portion 520 is assembled as shown in FIG. 8, axial rotation of the knob member 540 in a first direction rotates the base plate 50 and intermediate plate 52 towards each other and in a second direction rotates the base plate 50 and the intermediate plate 52 away from each about the screw axis SA. During normal use, the example displacement portion 520 rotates both the base plate 50 and the intermediate plate 52 in a horizontal plane.

FIG. 9 illustrates that the example limit portion 522 of the first adjustment system 60 is formed by threading the stop screw 532 into the base plate stop hole 144 such that a head portion 550 of the stop screw 532 engages stop projection 160 of the base plate 50 and a shaft portion 552 of the stop screw 532 extends into the stop slot 244 formed in the intermediate plate 52. The stop screw 532 limits movement of the base plate 50 and the intermediate plate 52 relative to each other by hitting opposite ends of the elongate stop slot to limit the maximum and minimum allowable distance between the base plate 50 and intermediate plate 52.

Turning now to FIGS. 7, 10, and 16, the example second adjustment system 62 will now be described in detail. FIG. 10 perhaps best shows that the example second adjustment system 62 comprises a second adjustment member 620 and an anchor screw 622. The example second adjustment member 620 comprises a wheel portion 630, a shaft portion 632, and a wheel opening 634. As shown in FIG. 10, the wheel portion 630 is circular and defines a radius R3. The shaft portion 632 of the example second adjustment member 620 defines an externally threaded shaft outer surface 640, while the wheel opening 634 defines an internally threaded wheel opening surface portion 642. The example anchor screw 622 defines a head portion 650 and a threaded shaft portion 652. The example second adjustment system 62 is formed by arranging the shaft outer surface 640 to engage the threaded inner surface of the second adjustment opening 272 formed in the intermediate plate 52 and with the knob portion 620 facing the upper surface 220 of the intermediate plate. Axial rotation of the second adjustment member 620 will cause the shaft outer surface 640 to enter the second adjustment opening 272 as shown in FIGS. 7 and 16.

The example anchor screw 622 is then arranged such that the threaded shaft portion 652 thereof engages the threaded inner surface portion 642 of the wheel opening 634. Continued axial rotation of the anchor screw 622 causes an end 654 of the shaft portion 652 to extend entirely through the wheel opening 634 and eventually engage the anchor opening 346 in the top plate 54. Continued axial rotation of the anchor screw 622 secures the end 654 of the anchor screw 622 within the anchor opening 346. Adhesive such as Loctite may be used to secure the screw end 654 within the anchor opening 346. Ideally, relative movement of the anchor screw 622 with respect to the top plate 54 is prevented. However, axial rotation of the of the second adjustment member 620 relative to the anchor screw 622 will force the distal end 336 of the top plate 54 away from the distal end 236 of the intermediate member 52 by deforming the top plate 54 at the hinge notch 350 formed therein. At this point, axial rotation of the top plate 54 relative to the intermediate plate 52 is substantially prevented, and the top plate 54 will rotate about the screw axis SA with the intermediate plate 52 when the first adjustment system 60 is operated.

To minimize a form factor of the first example precision aiming system 20, the radii R1, R2, and R3 are selected such that the radius R3 defined by the wheel portion 630 is larger than the radius R1 defined by the distal end surface portion 236 and smaller than the radius R2 defined by the curved wall portion 362. Further a diameter of the wheel portion (2×R3) is greater than a width dimension of the first example precision aiming system 20 as defined by a distance between the side edge portions 330 and 332 of the top plate 54. This allows a substantial portion of the outer peripheral edge of the wheel portion 630 to extend out from between upper surface portions of the base plate 50 and intermediate plate 52 and distal lower surface portion 364 of the top plate 54.

In use, the base plate 50 of the first example precision aiming system 20 is connected to the support device 24 and the top plate 54 of the first example precision aiming system 20 is connected to the pointing device 22. To accomplish the movement depicted between the situations depicted in FIG. 2A and 2B, the first example adjustment member 530 is rotated to cause the pointing device 22 to rotate about the screw axis SA and thus result in lateral or horizontal movement of the field of view center point 34 relative to the target center 42. To accomplish the movement depicted between the situations depicted in FIGS. 2B and 2C, the second example adjustment member 620 is rotated to cause the pointing device 22 to rotate about a hinge axis HA (FIGS. 7 and 16) and thus result in vertical (down) movement of the field of view center point 34 relative to the target center 42.

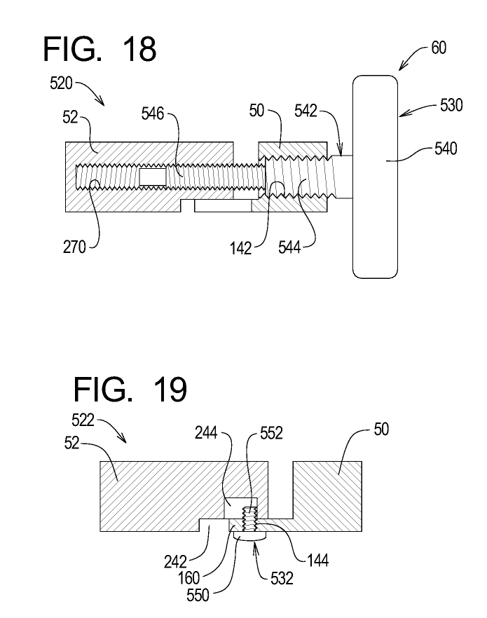

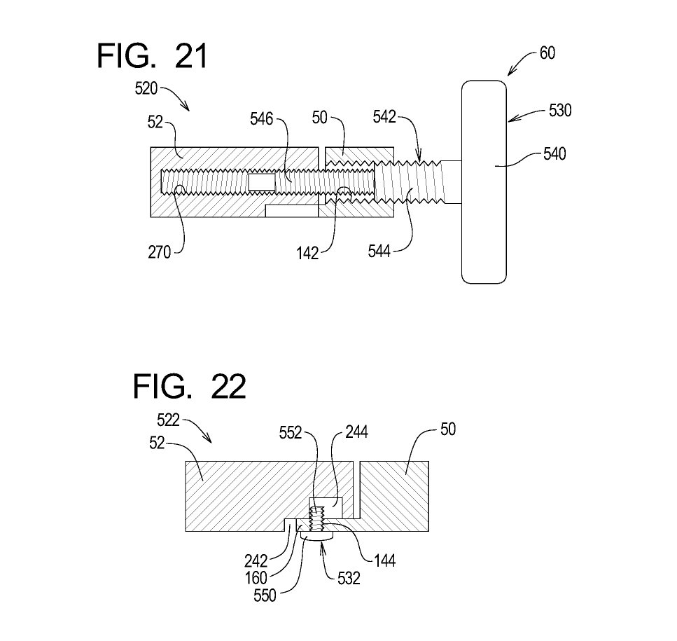

The first adjustment member 530 is shown at one end of its range of movement in FIGS. 17-19 and at a second end of its range of movement as shown in FIGS. 20-22. The example first adjustment system 60 is configured such that the range of movement shown by a comparison of FIGS. 17-19 with FIGS. 20-22 is accomplished by over four complete revolutions of the knob portion 540. Accordingly, a relatively large angular rotation of the knob portion 540 yields a very small angular rotation of the pointing device 22 about the screw axis SA.

The second adjustment member 620 is shown at one end of its range of movement in FIG. 7 and at a second end of its range of movement in FIGS. 15 and 16. The example second adjustment system 62 is configured such that the range of movement shown by a comparison of FIGS. 7 and 16 is accomplished by approximately three and a half complete revolutions of the wheel portion 630. Accordingly, a relatively large angular rotation of the wheel portion 630 yields a very small angular rotation of the pointing device 22 about the hinge axis HA.

### II. Second Example Precision Pointing Device

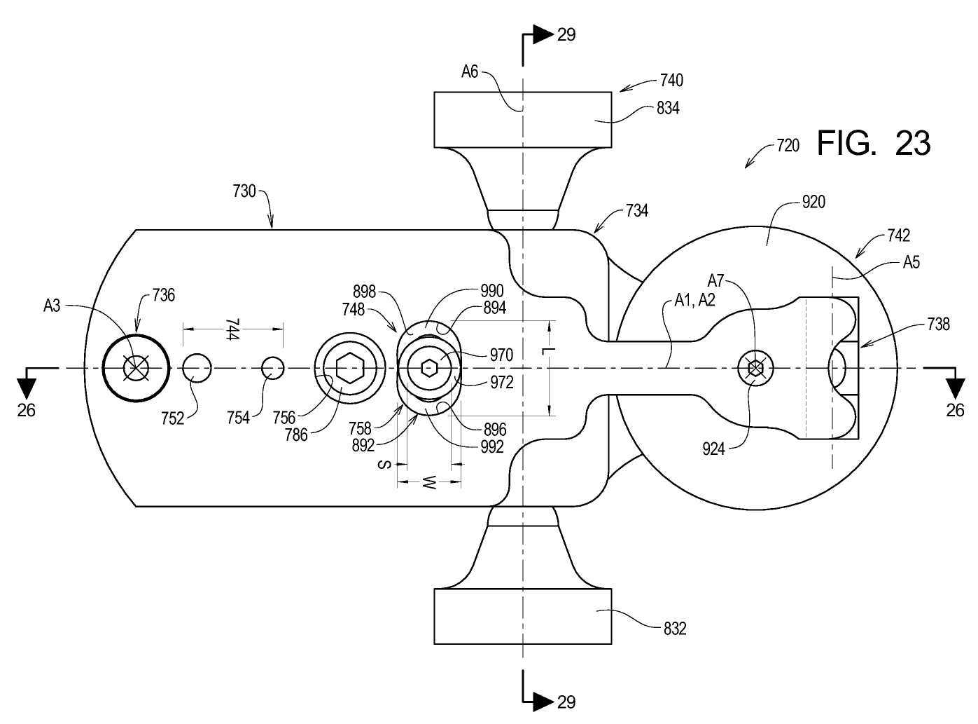

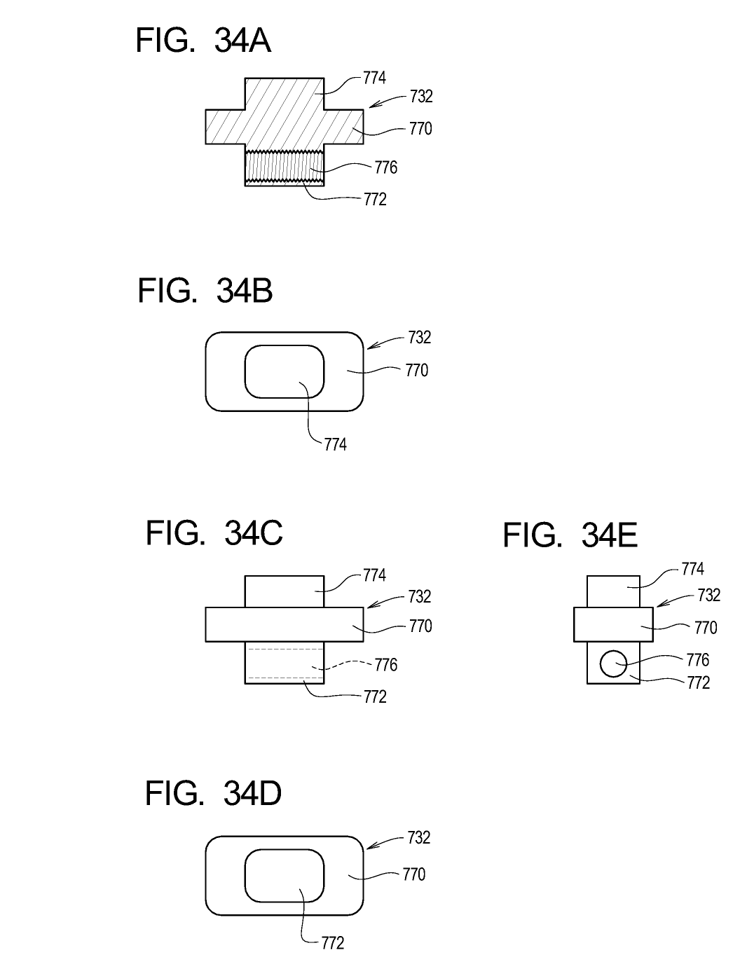

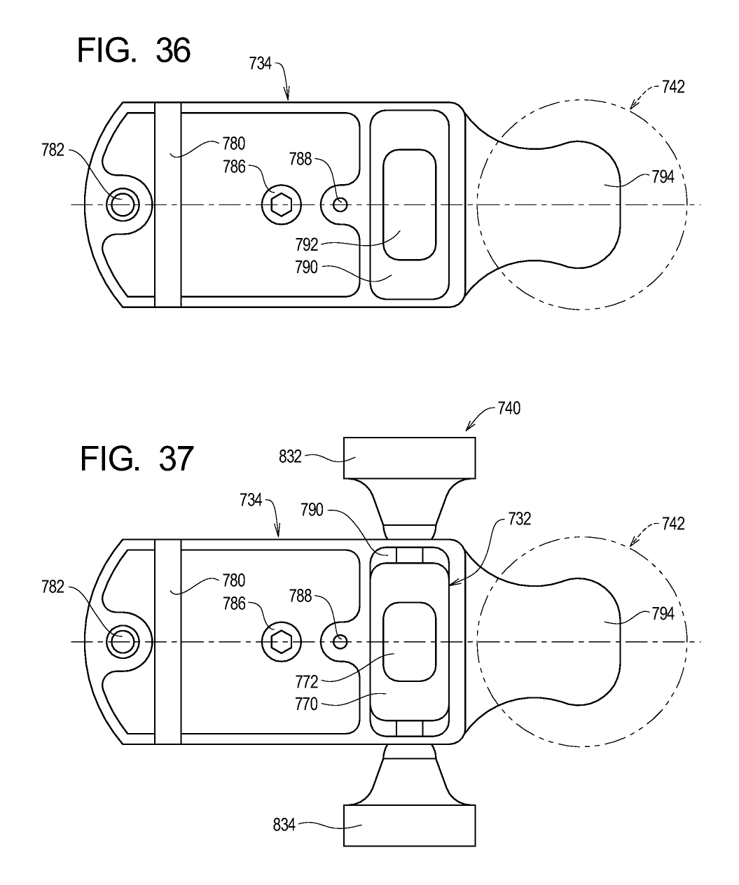

Referring now to FIGS. 23-41 of the drawing, depicted therein is a second example precision aiming device 720 constructed in accordance with, and embodying, the principles of the present invention. As will be described in further detail below, the second example precision aiming device 720 is adapted to support a pointing device such as the example pointing device 22 and to be supported by a support device such as the support device 24 described above.

The example precision aiming device 720 comprises a base plate 730, an intermediate block or member 732, a top plate 736, a pivot assembly 736, a level indicator 738, a first (lateral) adjustment system 740, a second (vertical) adjustment system 742, a support mounting system 744, a device mounting system 746, and a limit assembly 748.

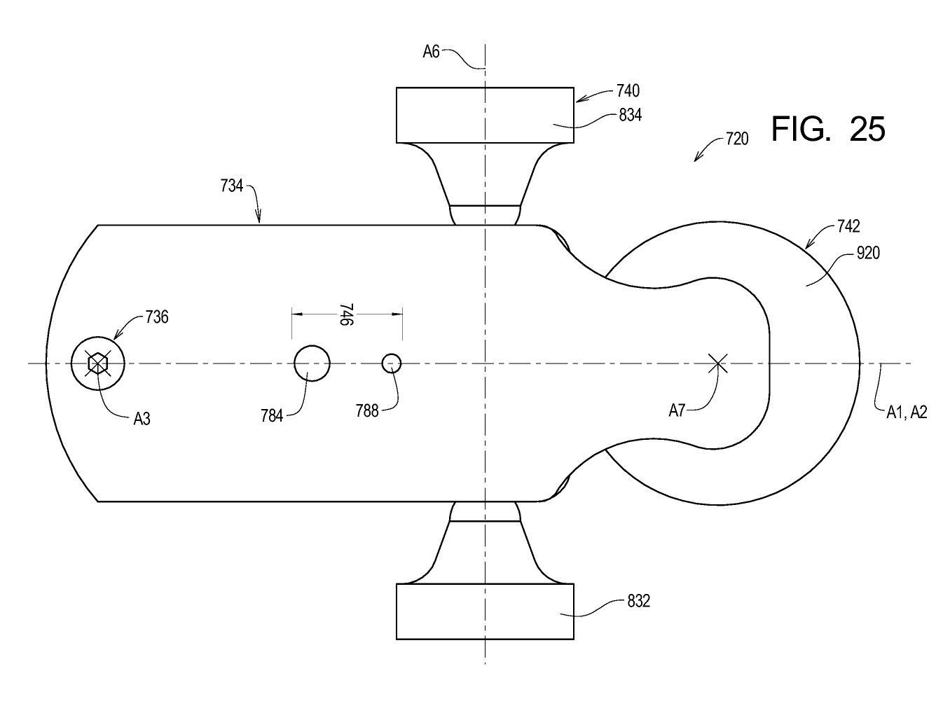

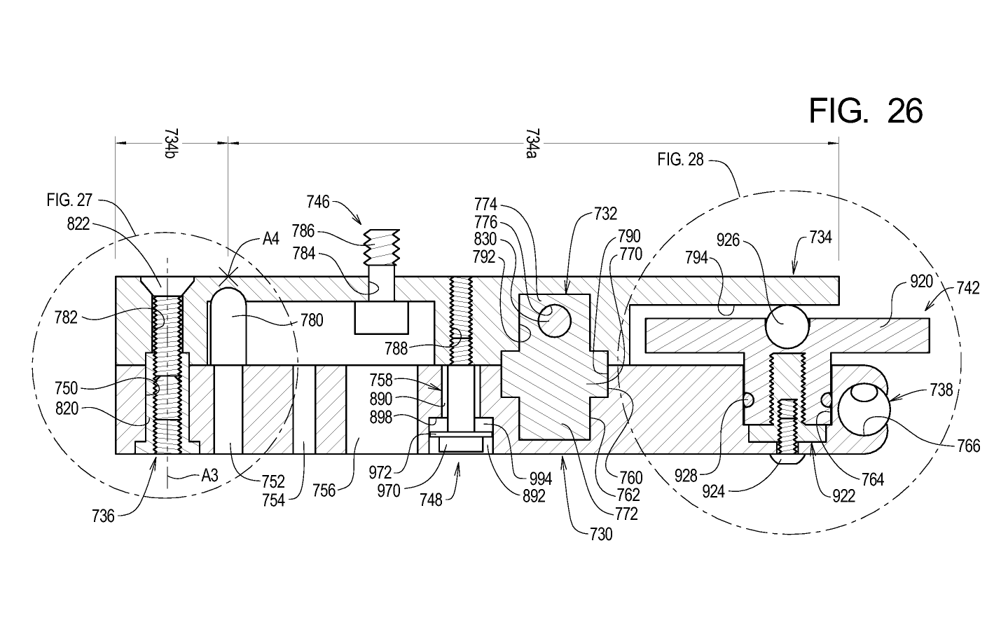

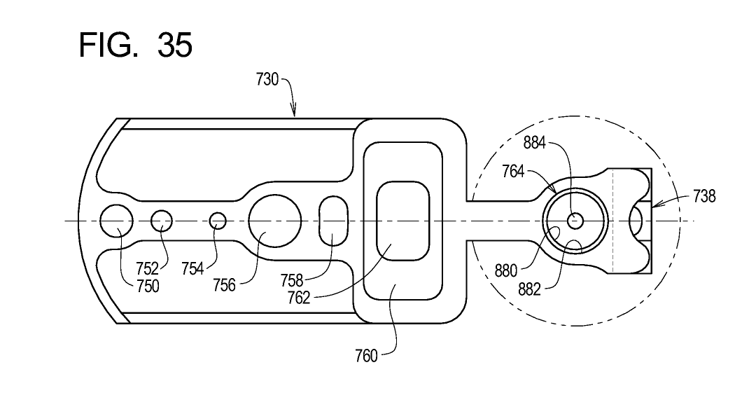

FIGS. 26 and 35 illustrate that the example base plate 730 defines a base plate pivot opening 750, a support mounting cavity 752, a support alignment cavity 754, a device mount access opening 756, a limit opening 758, a first intermediate block cavity 760, a first intermediate block recess 762, a base plate end opening 764, and a clip cavity 766. FIGS. 26, 33, 34A-D, and 37 illustrate that the example intermediate block 732 defines a main portion 770, a base plate portion 772, a top plate portion 774, and an adjustment opening 776. FIGS. 25, 26, 33, and 37 illustrate that the example top plate 734 defines a top plate pivot groove 780, a top plate pivot opening 782, a device mount opening 784, a device mounting screw 786, a limit cavity 788, a top plate block cavity 790, a top plate block recess 792, a top plate bearing surface 794, a top plate first edge opening 796, and a top plate second edge opening 798.

The top plate pivot groove 780 allows movement of a distal portion 734a of the top plate 734 defining the top plate mounting opening 782, limit cavity 788, block cavity 790, block recess 792, and bearing surface 794 relative to a proximal portion 734b of the top plate 734 defining the top plate pivot opening 782 (FIG. 26). The distal portion 734a is thus located entirely on one side of the top plate pivot groove 780, while the proximal portion 734b is located on the opposite side of the top plate pivot groove 780. Further, the top plate 734 is made of material capable of resiliently deforming to allow the distal portion 734a of the top plate 734 to move relative to the proximal portion 734b of the top plate 734. In particular, the top plate pivot groove 780 reduces the thickness of the material forming the top plate 734 to form what is commonly referred to as a living hinge that allows limited flexing or relative movement of the distal portion 734a relative to the proximal portion 734b without fatiguing or otherwise damaging the top plate 734.

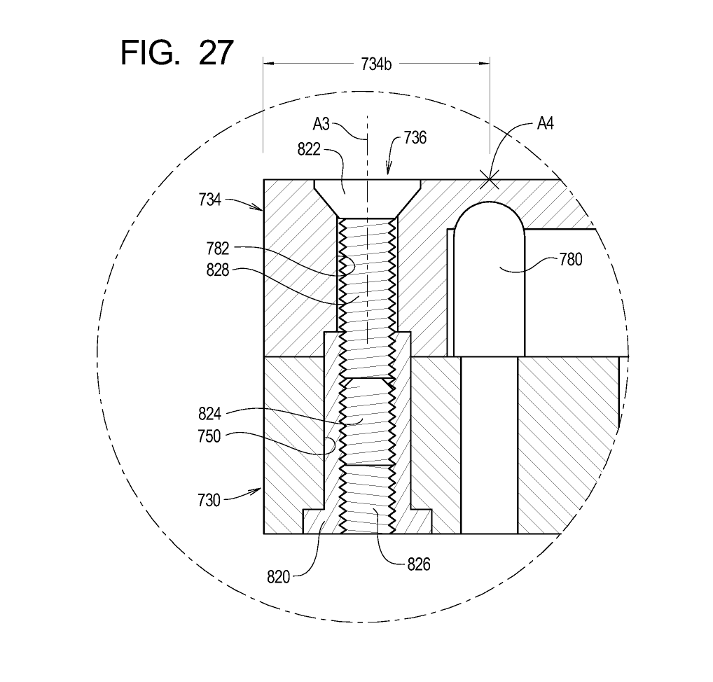

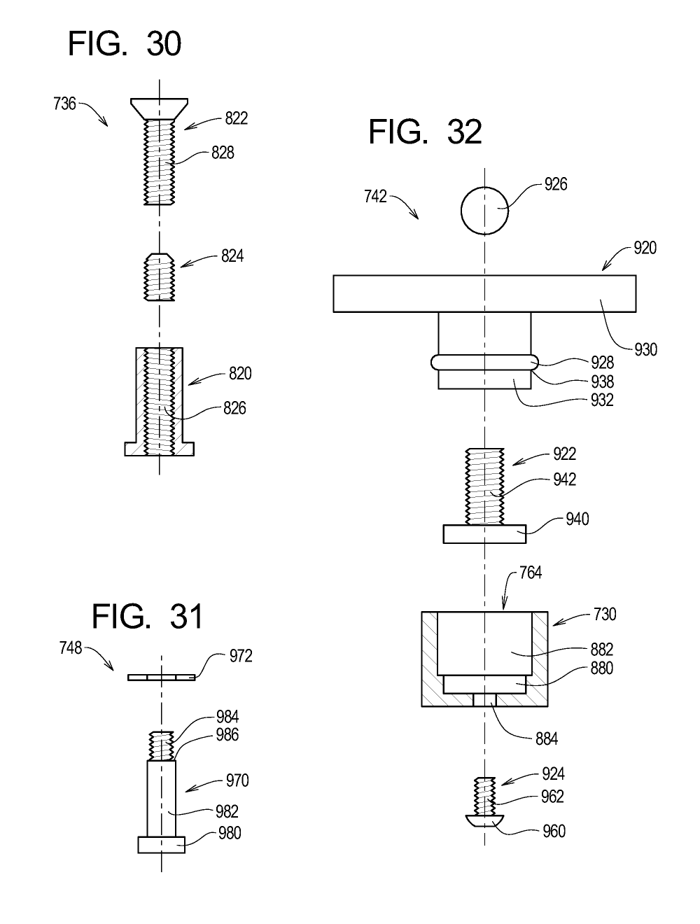

FIGS. 27 and 30 illustrate that the example pivot assembly 736 comprises a pivot post 820, a pivot main screw 822, and a pivot set screw 824. The example pivot post 820 defines a pivot post internal cavity 826, and the pivot main screw 882 defines a threaded shaft 828.

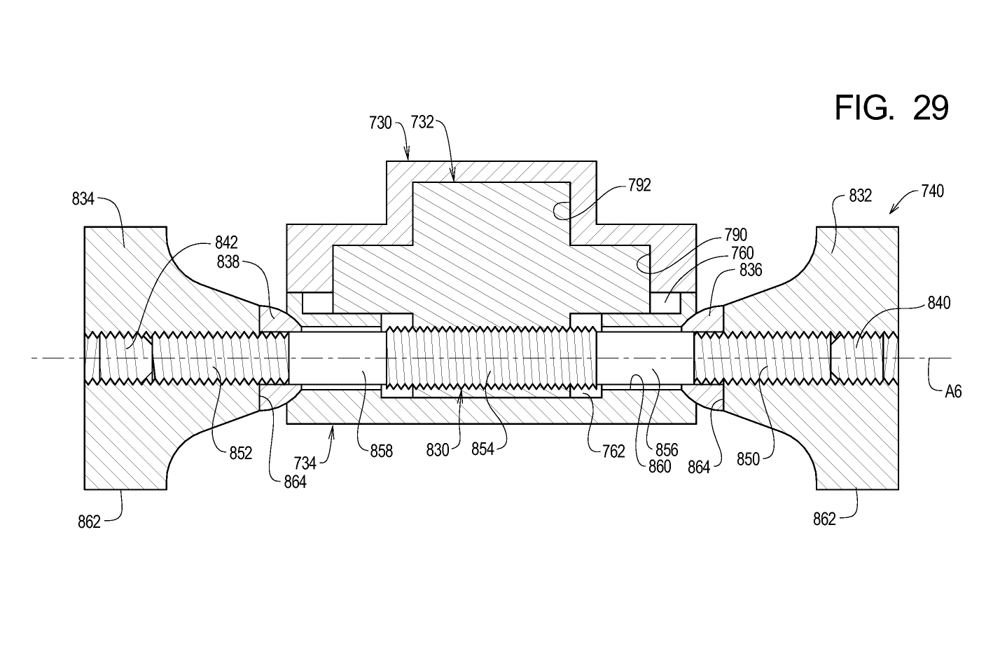

FIGS. 29, 33, and 41 illustrate that the example first adjustment system 740 comprises an adjustment rod or member 830, a first adjustment knob 832, a second adjustment knob 834, a first knob collar 836, a second knob collar 838, a first knob set screw 840, and a second knob set screw 842. The example adjustment rod 830 defines first and second distal end portions 850 and 852, a displacement portion 854, and first and second intermediate portions 856 and 858. Each of the first and second adjustment knobs 832 and 834 defines an adjustment rod opening 860, a finger surface 862, and an inner knob surface 864. Each of the first and second knob collars 836 and 838 defines a knob collar opening 870, an outer collar surface 872, and an inner collar surface 874.

As shown in FIGS. 26, 28, and 32, the base plate end opening 764 defines an end opening inner portion 880, an end opening hub portion 882, and an end opening screw portion 884. And as shown in FIGS. 23, 26, and 40, the limit opening 758 in the base plate 730 defines a limit opening inner portion 890 and a limit opening outer portion 892. The limit opening outer portion 892 defines first and second limit end surfaces 894 and 896, and a limit shoulder 898 is formed by the base plate 730 at the juncture of the limit opening inner portion 890 and the limit opening outer portion 892.

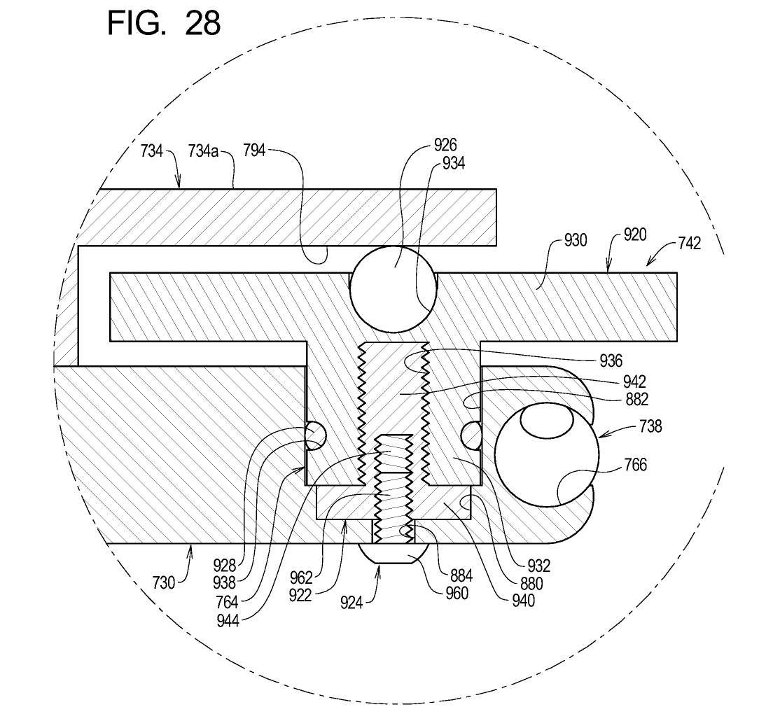

FIGS. 28, 32, and 39 illustrate that the example second adjustment system 742 comprises a adjustment wheel 920, a wheel post 922, a wheel post screw 924, a wheel bearing member 926, and a wheel 0-ring 928. The example adjustment wheel 920 defines a main wheel portion 930 and a wheel hub portion 932. The wheel main portion 930 defines a bearing recess 934. A hub internal cavity 936 is defined within the wheel hub portion 932, and a hub annular recess 938 is defined around the wheel hub portion 932. The wheel post 922 defines a post main portion 940, a post projection 942, and a post cavity 944. The wheel post screw 924 defines a wheel post screw head portion 960 and a wheel post screw shaft portion 962.

The example limit assembly 748 comprises a limit screw 970 and a limit screw washer 972. The limit screw defines a limit screw head portion 980, a limit screw first shaft portion 982, a limit screw second shaft portion 984, and a limit screw shoulder surface 986.

To assemble the second example precision aiming system 720, the first adjustment system 740 and second adjustment system 742 are initially pre-assembled as follows.

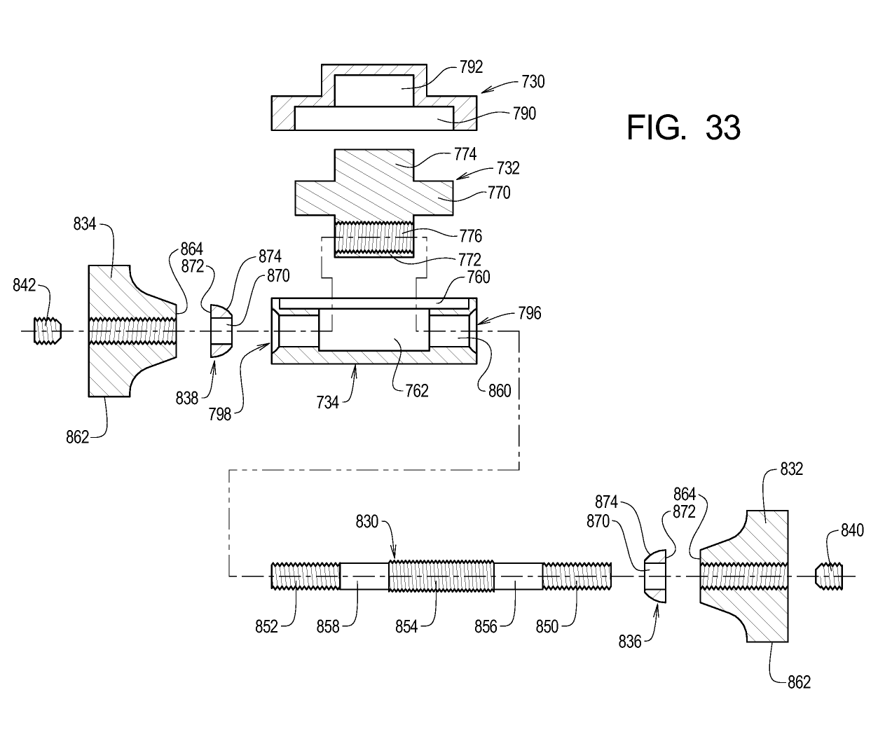

The pre-assembly of the first adjustment system 740 is best shown with reference to FIGS. 29 and 33. Initially, the intermediate block 732 is arranged such that the main portion 770 thereof is at least partly arranged within the top plate block cavity 790 and the base plate portion 772 thereof is arranged within the top plate block recess 792. At this point, the adjustment opening 776 in the intermediate block 732 is aligned with the top plate first and second edge openings 796 and 798. The second distal end portion 852 of the adjustment rod 830 is inserted through the top plate first edge opening 796 and the adjustment opening 776. The displacement portion 854 of the adjustment rod 830 is externally threaded to match internal threads of the adjustment opening 776, and the adjustment rod 830 is axially rotated such that the second distal end portion 852 thereof passes through the top plate second edge opening 798. At this point, the adjustment rod 830 is centered with respect to the top plate portion 774 of the intermediate block 732 and the top plate portion 774 is centered with respect to the top plate block recess 792. The first and second intermediate portions 856 and 858 of the adjustment rod 830 are within the top plate first and second edge openings 796 and 798. The first and second knob collars 836 and 838 are then arranged over the first and second distal end portions 850 and 852 of the adjustment rod 830, and internal openings in the first and second adjustment knobs 832 and 834 are threaded onto the first and second distal end portions 850 and 852. The first and second knob set screws 840 and 842 are threaded into the internal openings of the first and second adjustment knobs 832 and 834 and against the first and second distal end portions 850 and 852 of the adjustment rod 830.

The pre-assembly of the second adjustment system 742 is best shown in FIGS. 28 and 32. Initially, the post main portion 940 of the wheel post 922 is secured within the end opening inner portion 880 of the base plate end opening 764 by inserting the shaft portion 962 of the wheel post screw 926 through the end opening screw portion 884 of the base plate end opening 764 and threading the shaft portion 962 into the post cavity 944 of the wheel post 922. At this point, the post projection 942 is arranged within the end opening hub portion 882. The hub internal cavity 936 of the wheel hub portion 932 is internally threaded, and the post projection 942 of the wheel post 922 is externally threaded. With the wheel O-ring 928 within the hub annular recess 938, the adjustment wheel 920 is next axially rotated such that the hub internal cavity 936 is threaded onto the post projection 942 of wheel post 922. The wheel bearing member 926 is then arranged within the hub bearing recess 934.

Before or after the first and second adjustment systems 740 and 742 are preassembled, the level indicator 738 is secured to the base plate 730 by inserting the level indicator 738 into the clip cavity 766.

At this point, the top plate 734 is arranged such that: the top plate pivot opening 782 is aligned with the base plate pivot opening 750, the top plate limit cavity 788 is aligned with the base plate limit opening 758, the intermediate block main portion 770 is at least partly within the base plate block cavity 760, the intermediate block base plate portion 772 is within the base plate block recess 762, and the wheel bearing member 926 is in contact with the bearing surface 794 defined by the top plate 734. The pivot assembly 736 is next formed by inserting the pivot post 820 into the base plate pivot opening 750 and inserting the pivot main screw 822 through the top plate pivot opening 782. At this point, axial rotation of the pivot main screw 822 causes the pivot set screw shaft 828 to engage the pivot post internal cavity 826 to rotatably attach the top plate 734 to the base plate 730. The pivot set screw 824 is threaded into the pivot post internal cavity 826 to secure the pivot main screw 822 in place. The top plate 734 is, at this point, pivotably connected to the base plate 730.

Next, the example limit assembly 748 is formed. In particular, the limit screw 970 is inserted through the limit screw washer 972 and inserted through the base plate limit opening 758 such that the threaded second shaft portion 984 of the limit screw 970 is threaded into the threaded internal cavity defined by the limit cavity 788 formed in the top plate 734. The first shaft portion 982 of the limit screw 970 engages the top plate 734 such that a location of the head portion 980 of the limit screw 970 is fixed relative to the top plate 734. At this point, the head portion 980 of the limit screw 970 and the limit screw washer 972 are arranged at least partly within the base plate limit opening 758.

So assembled, the example base plate 730 defines a base plate axis A1, and the distal portion 734a of the example top plate 734 defines a top plate axis A2. The pivot assembly 736 secures the proximal portion 734b of the top plate 734 to the base plate 730 for rotation about a first pivot axis A3. The top plate pivot groove 780 defines a second pivot axis A4, and the top plate 734 is capable of deforming adjacent to the top plate pivot groove 780 to allow the top plate axis A2 to pivot towards and away from the base plate axis A1. When retained within the clip cavity 766, the level indicator 738 defines a level axis A5. The first adjustment system 740 defines a first adjustment axis A6 extending along the longitudinal axis of the adjustment rod 830, while the second adjustment system 742 defines a second adjustment axis A7 extending along the longitudinal axis of the wheel main portion 930 and wheel post screw 924. The example wheel bearing member 926 lies along the second adjustment axis A7.

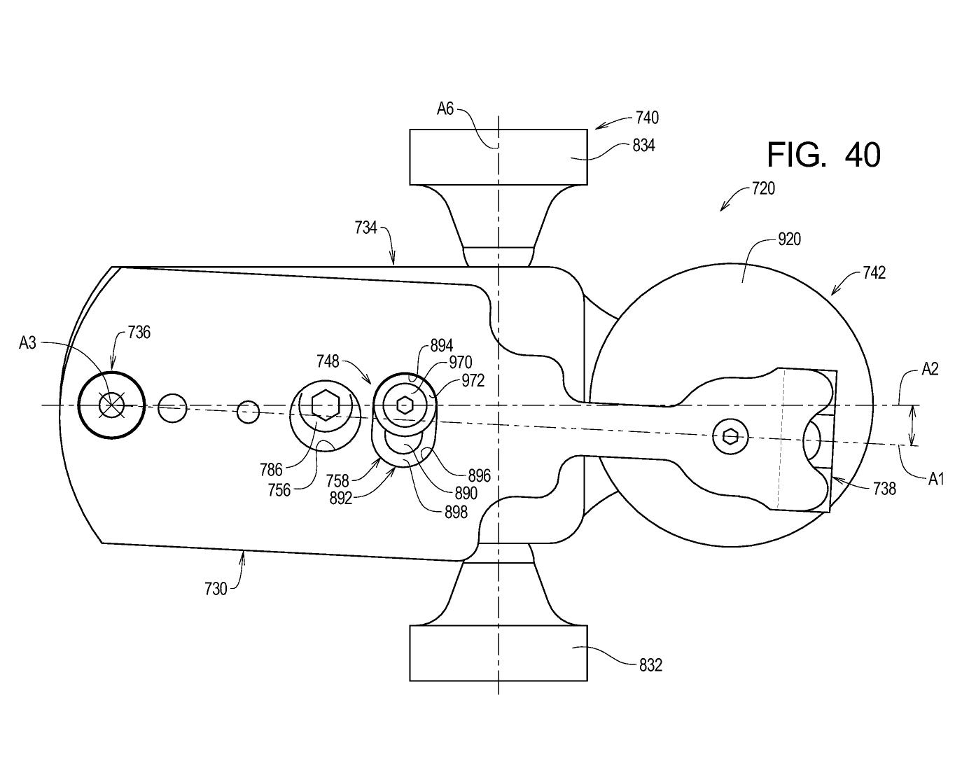

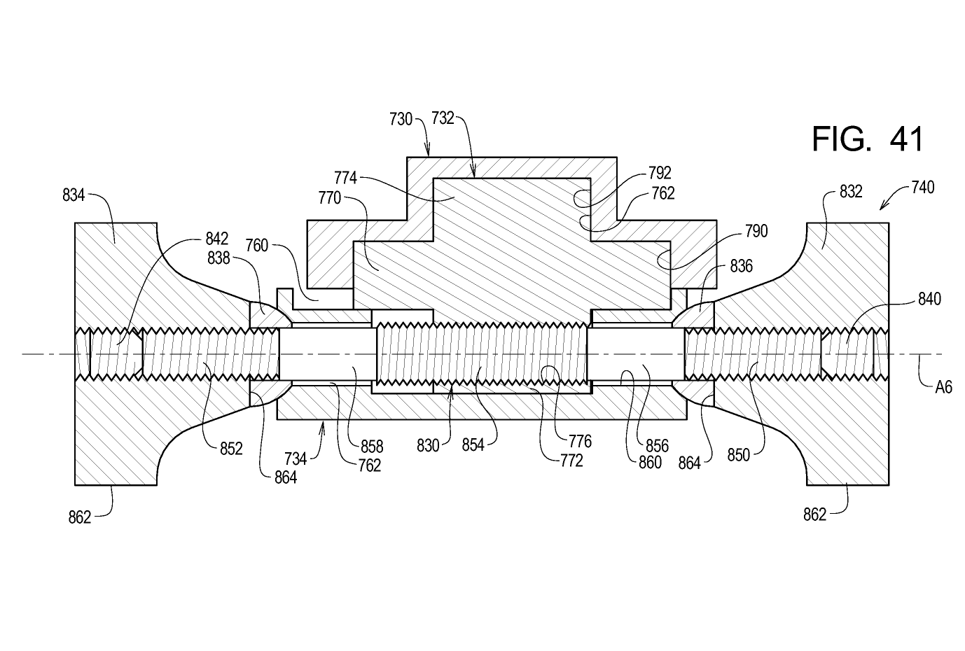

In particular, axial rotation of the adjustment rod 830 (using either of the first and second adjustment knobs 832 and 834) of the first adjustment system 740 in a first direction causes the adjustment rod 830 to displace the intermediate block 732 along the first adjustment axis A6 such that the intermediate block 732 engages the base plate 730 to rotate the top plate 734 about the first pivot axis A3 as perhaps best shown by a comparison of FIG. 29 with FIG. 41 and of FIG. 23 with FIG. 40. As shown in FIGS. 29, 37, and 41, the top plate block cavity 790 and top plate block recess 792 are longer than the corresponding main portion 770 and bottom plate portion 772 of the intermediate block 732 along the first adjustment axis A6. However, the base plate block cavity 760 and base plate block recess 762 snugly receive the corresponding main portion 770 and top plate portion 774, respectively, of the intermediate block 732 to inhibit movement of the intermediate block 732 relative to the base plate 730. The top plate block cavity 790 and top plate block recess 792 thus allow guided movement of the intermediate block 732 relative to the top plate 734, while the base plate block cavity 760 and base plate block recess 762 prevent movement of the intermediate block 732 relative to the base plate 730 along the first adjustment axis A6. The adjustment knobs 832 and 834 and knob collars 836 and 838 engage the top plate 734 to maintain a lateral position of the adjustment rod 830 relative to the top plate 734 along the first adjustment axis A6, but the intermediate block 732 moves relative to the top plate 734 with axial rotation of the adjustment rod 830 due to the threaded engagement of the externally threaded adjustment knob displacement portion 854 and the internally threaded adjustment opening 776 in the intermediate block 732. The example intermediate block 732 may be integrally formed with the bottom plate 730, but having a separate intermediate block 732 can simplify fabrication and assembly of the second example precision aiming system 720 of the present invention. Axial rotation of the adjustment rod 830 causes displacement of the intermediate block 732 relative to the top plate 734, and relative displacement of the intermediate block 732 relative to the top plate 734 results in pivoting movement of the top plate 734 relative to the base plate 730 about the first pivot axis A3.

Although not depicted in the drawings, it should be clear from FIGS. 23, 29, 40, and 41 that axial rotation adjustment rod 830 in a second direction causes the top plate 734 to pivot in the opposite direction about the pivot axis A3 such that the top plate axis A2 can be arranged on the other side of the base plate axis Al from the position depicted in FIGS. 40 and 41. The example first adjustment system 740 thus allows the top plate axis A2 to be displaced relative to the base plate axis Al between first and second end positions as will be described in further detail below.

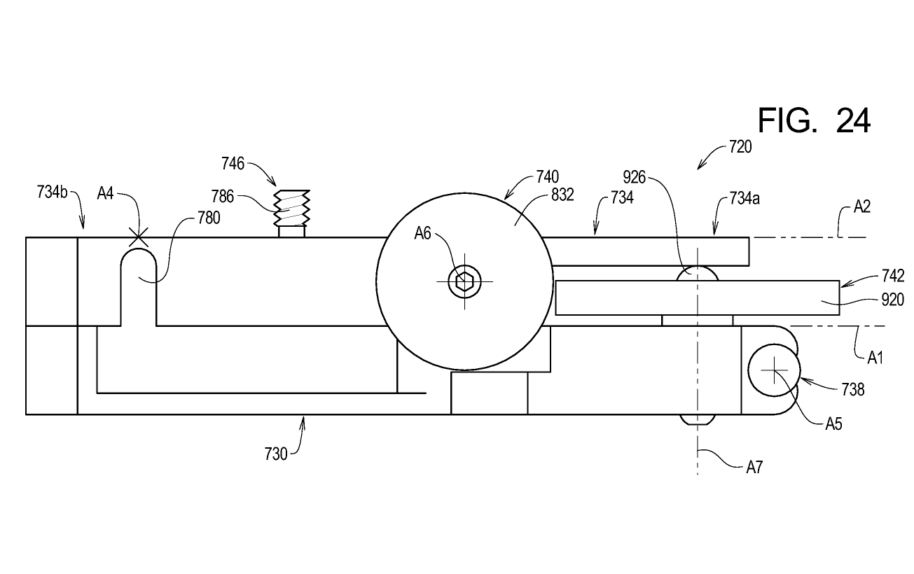

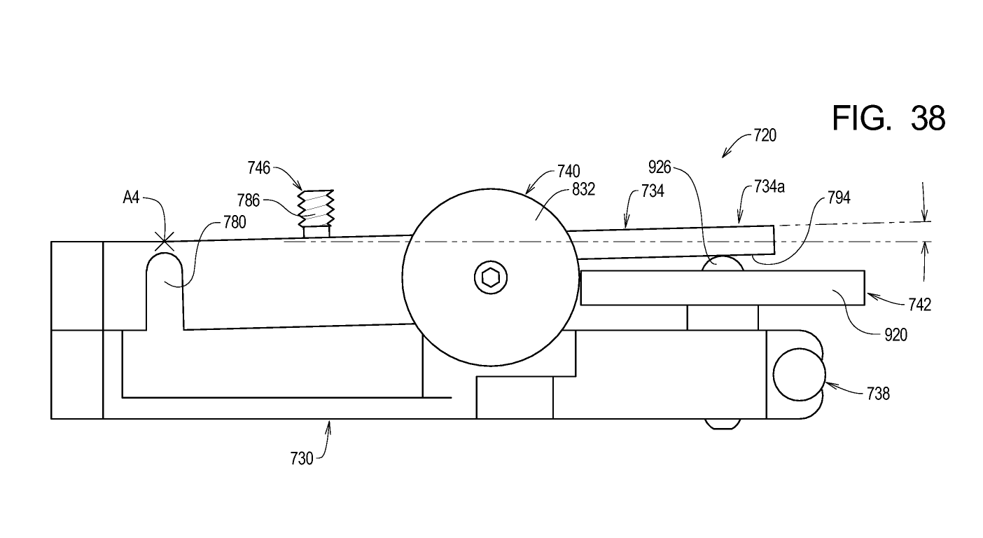

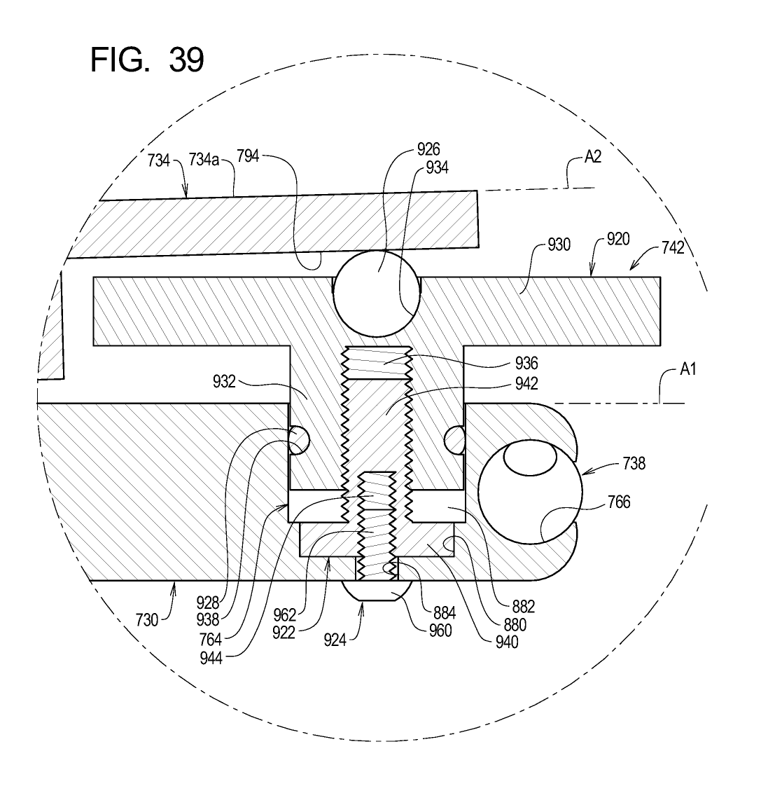

In addition, axial rotation of the adjustment wheel 920 of the second adjustment system 742 displaces the adjustment wheel 920 and wheel bearing member 926 along the second adjustment axis A7 such that the bearing member 926 engages the bearing surface 794 on the top plate 734 to cause the top plate 734 to pivot about the second pivot axis A4 relative to the base plate 730 as perhaps best shown by a comparison of FIG. 28 with FIG. 39 and of FIG. 24 with FIG. 38. The example second adjustment system 742 is configured such that the maximum range of movement allows is accomplished by approximately multiple revolutions of the wheel portion 930. Accordingly, a relatively large linear displacement of an annular outer surface of the wheel portion 930 yields a very small angular rotation of the pointing device 22 about the hinge axis A4.

FIGS. 23, 26, and 40 further show that the limit screw 970 is arranged such that the externally threaded second shaft portion 984 thereof is threaded into the internally threaded limit cavity 788 in the top plate 734 until the shaft shoulder surface 986 comes into contact with the top plate 734. Further, the example the outer portion 892 of the limit opening 758 formed in the base plate 730 defines a length dimension L and a width dimension W and that the head portion 980 of the example limit screw 970 defines a spacing dimension S that is less than the width dimension W of the limit opening 758. In the example limit assembly 748, the limit opening 758 is arcuate and elongate and the limit screw head portion 980 is circular. When the limit screw head portion 980 is located at the center of the limit opening outer portion 892 as shown in FIG. 23, first and second limit end gaps 990 and 992 are formed between the first and second limit end surfaces 894 and 896 defined by the limit opening outer portion 892. Accordingly, as the first example adjustment system 740 rotates the top plate 734 about the first pivot axis A3 relative to the base plate 730, the limit screw head portion 980 travels within the limit opening outer portion 892 through a limited arc defined by the first and second end gaps 990 and 992.

FIG. 26 illustrates, when the top plate axis A2 is substantially parallel to the base plate axis Al, an internal gap 994 exists between head portion 980 of the limit screw 970 and the limit shoulder 898 defined by the base plate limit opening 764. The dimensions of the second limit gap 890 are determined by relative effective lengths of the limit opening inner portion 890 and the limit screw first shaft portion 982. The second limit gap 890 determines the limit of the pivoting movement of the top plate 734 relative to the base plate 730 about the pivot axis A3. In particular, when the limit screw head portion 980 travels the length of the limit gap 890, the limit screw head portion 980 comes into contact with the limit shoulder 898, and further movement of the limit screw 970 is prevented. Accordingly, as the second example adjustment system 742 rotates the top plate 734 about the pivot axis A3 relative to the base plate 730, the limit screw head portion 980 travels within the limit opening outer portion 892 through a limited arc defined by the internal gap 994.

The example first adjustment system 740 is configured such that a range of movement of approximately 6 degrees (e.g., approximately 3 degrees in each direction from the positions in which the base plate axis A1 and top plate axis A2 are aligned) by approximately 12 and ½ complete revolutions of either of the adjustment knobs 832 and 834. In addition, the first and second adjustment knobs 832 and 834 are approximately 1.25″ in diameter. Accordingly, relatively large linear displacement of the finger surfaces 862 of either of the knobs 832 and 834 yields a relatively small angular rotation the top plate axis A2 relative to the base plate axis A1 about the first pivot axis A3.

The example second adjustment system 742 is configured such a range of movement of approximately 3 degrees (e.g., approximately 3 degrees from the position in which the base plate axis A1 and top plate axis A2 are aligned and parallel) by approximately 7 complete revolutions of the wheel portion 930. In addition, the main wheel portion 930 of the adjustment wheel 920 is approximately 2″ in diameter. Accordingly, relatively large linear displacement of the annular surface of the main wheel portion 930 yields a relatively small angular rotation the top plate axis A2 relative to the base plate axis A1 about the hinge axis A4.

What is claimed is:

1. An aiming device comprising:
a base plate;
a top plate;
a pivot assembly for connecting the top plate to the base plate for rotation about a first pivot axis;
a pivot groove formed in the top plate for allowing deformation of at least a portion of the top plate relative to the base plate about a second pivot axis;
a first adjustment system for causing relative movement between the top plate and the base plate relative about the first pivot axis; and
a second adjustment system for causing relative movement between at least a portion of the top plate and the bottom plate about the second pivot axis.

2. An aiming device as recited in claim 1, further comprising an intermediate member, where the first adjustment system acts on the intermediate member to cause relative movement between the top plate and the base plate.

3. An aiming device as recited in claim 2, in which:
the top plate supports the intermediate member for guided movement along the first adjustment axis relative to the top plate; and
the base plate supports the intermediate member such that the base plate moves with the intermediate member along the first adjustment axis relative to the top plate.

4. An aiming device as recited in claim 2, in which:
the intermediate member defines at least one threaded displacement opening; and
the first adjustment system comprises an adjustment member defining at least one threaded shaft portion that engages the at least one threaded displacement opening such that axial rotation of the adjustment member displaces the intermediate member relative to the base plate.

5. An aiming device as recited in claim 3, in which:
the first adjustment system defines a first adjustment system axis; and
the adjustment member is configured to engage the top plate to allow axial rotation of the adjustment member about the first adjustment system axis and prevent displacement of the adjustment member along the first adjustment system axis.

6. An aiming device as recited in claim 1, in which the second adjustment system comprises an adjustment wheel supported relative to the base plate and such that axial rotation of the adjustment wheel about the second adjustment axis causes displacement of a distal portion of the top plate relative to the proximal portion of the top plate and to the base plate.

7. An aiming device as recited in claim 6, in which:
the adjustment wheel defines a first threaded portion; and
a second threaded portion is supported relative to the base plate; whereby the first threaded portion engages the second threaded portion such that
axial rotation of the adjustment wheel displaces the adjustment wheel relative to the base plate, and
the adjustment wheel acts on the top plate.

8. An aiming system as recited in claim 6, in which:
the second adjustment system comprising a wheel bearing member; and
the wheel bearing member is supported between the adjustment wheel and a bearing surface defined by the top plate such that the adjustment wheel acts on the top plate through the wheel bearing member and the bearing surface.

9. An aiming system as recited in claim 7, in which the second threaded portion is formed on a wheel post supported by the base plate.

10. A method of aiming a pointing device supported from a support device:
securing a base plate to the support device;
securing the pointing device to a top plate;
pivotably connecting a proximal portion of the top plate to the base plate for rotation about a first pivot axis;
forming a pivot groove in the top plate for allowing deformation of a distal portion of the top plate relative to the proximal portion of the top plate about a second pivot axis;
displacing the top plate relative to the base plate about the first pivot axis; and
displacing the distal portion of the top plate relative to the proximal portion of the top plate about the second pivot axis.

11. A method as recited in claim 10, in which the step of displacing the top plate relative to the base plate about the first pivot axis comprises the step of arranging an intermediate member such that the first adjustment system acts on the intermediate member to cause relative movement between the top plate and the base plate.

12. A method as recited in claim 11, in which the step of displacing the top plate relative to the base plate about the first pivot axis comprises the step of:
supporting the intermediate member for guided movement along the first adjustment axis relative to the top plate; and
supporting the intermediate member relative to the base plate such that the base plate moves with the intermediate member along the first adjustment axis relative to the top plate.

13. A method as recited in claim 11, in which the step of displacing the top plate relative to the base plate about the first pivot axis comprises the step of:
forming at least one threaded displacement opening in the intermediate member;
providing an adjustment member defining at least one threaded shaft portion;
arranging the adjustment member such that the at least one threaded shaft portion engages the at least one threaded displacement opening; and
axially rotating the adjustment member to displace the intermediate member relative to the base plate.

14. A method as recited in claim 10, in which the step of displacing the top plate relative to the base plate about the second pivot axis comprises the steps of:
supporting an adjustment wheel relative to the base plate; and
axially rotating the adjustment wheel about the second adjustment axis to displace the distal portion of the top plate relative to proximal portion of the top plate and the base plate.

15. A method as recited in claim 14, in which the step of displacing the top plate relative to the base plate about the second pivot axis comprises the steps of:
forming a first threaded portion on the adjustment wheel; and
supporting a second threaded portion relative to the base plate;
engaging the first threaded portion with the second threaded portion such that
axial rotation of the adjustment wheel displaces the adjustment wheel relative to the base plate, and
the adjustment wheel acts on the top plate.

16. A method as recited in claim 14, in which the step of displacing the top plate relative to the base plate about the second pivot axis comprises the steps of:
providing a wheel bearing member; and
supporting the wheel bearing member between the adjustment wheel and a bearing surface defined by the top plate such that the adjustment wheel acts on the top plate through the wheel bearing member and the bearing surface.

17. A method as recited in claim 15, in which the second threaded portion is formed on a wheel post supported by the base plate.

18. An aiming device for use with a pointing device and a support device, the aiming device comprising:
a base plate adapted to be detachably attached to the support device;
a top plate adapted to be detachably attached to the pointing device;
a pivot assembly for connecting a proximal portion of the top plate to the base plate for rotation about a first pivot axis;
a pivot groove formed in the top plate for allowing deformation of a distal portion of the top plate relative to the proximal portion of the top plate about a second pivot axis;
a first adjustment system for causing relative movement between the top plate and the base plate relative about the first pivot axis, the first adjustment system comprising
an intermediate member supported by the top plate for movement along a first adjustment axis,
an adjustment rod supported by the top plate for axial rotation relative to the first adjustment axis, and
the first adjustment system acts on the intermediate member to cause relative movement between the top plate and the base plate; and
a second adjustment system for causing relative movement between a distal portion of the top plate and the proximal portion of the top plate about the second pivot axis, the second adjustment system comprising an adjustment wheel that is supported relative to the base plate and such that axial rotation of the adjustment wheel about the second adjustment axis causes displacement of distal portion of the top plate relative to the proximal portion of the top plate and thus to the base plate.

19. An aiming device as recited in claim 18, in which:
the top plate supports the intermediate member for guided movement along the first adjustment axis relative to the top plate; and
the base plate supports the intermediate member such that the base plate moves with the intermediate member along the first adjustment axis relative to the top plate.

20. An aiming device as recited in claim 18, in which:
the intermediate member defines at least one threaded displacement opening; and
the first adjustment system comprises an adjustment wheel defining at least one threaded shaft portion that engages the at least one threaded displacement opening such that axial rotation of the adjustment member displaces the intermediate member relative to the base plate.

21. An aiming device as recited in claim 20, in which:
the adjustment wheel defines a first threaded portion; and
a second threaded portion is supported relative to the base plate; whereby
the first threaded portion engages the second threaded portion such that
axial rotation of the adjustment wheel displaces the adjustment wheel relative to the base plate, and
the adjustment wheel acts on the top plate.
